(19) United States
(12) Patent Application Publication
(10) Pub. No.: US 2026/0234012 A1
(43) Pub. Date: Aug. 13, 2026

(54) FLUORIDE-CONTAINING AMMONIUM SALTS AND METHODS OF PRODUCTION AND USES THEREOF

(71) Applicant: Massachusetts Institute of Technology, Cambridge, MA (US)

(72) Inventors: Yet-Ming Chiang, Weston, MA (US); Camden Hunt, New Haven, CT (US); Benjamin Mowbray, Cambridge, MA (US)

(73) Assignee: Massachusetts Institute of Technology, Cambridge, MA (US)

(21) Appl. No.: 19/633,238

(22) Filed: Mar. 30, 2026

Related U.S. Application Data
(63) Continuation of application No. PCT/US2025/037704, filed on Jul. 15, 2025.
(60) Provisional application No. 63/682,496, filed on Aug. 13, 2024.

(51) Int. Cl. C01C 1/16; C01B 33/20; C01B 33/46

(52) U.S. Cl. CPC C01C 1/162; C01B 33/20; C01B 33/46; C01P 2002/72; C01P 2002/85; C01P 2002/86; C01P 2004/03

(57) ABSTRACT

Disclosed herein are fluoride-containing ammonium salts and methods of production and uses thereof. For example, methods of producing ammonium fluoride by combining a material comprising a fluorosilicate with an amine are disclosed. In some examples, the material comprising a fluorosilicate comprises a waste product, such as a waste product from ore processing (e.g., phosphate ore processing), fertilizer production, and/or aluminum production and/or refinement.

### RELATED APPLICATIONS

This application is a continuation of International Patent Application No. PCT/US2025/037704, filed Jul. 15, 2025, which claims priority under 35 U.S.C. § 119(e) to U.S. Provisional Patent Application No. 63/682,496, filed Aug. 13, 2024, each of which is hereby incorporated herein by reference in its entirety.

### GOVERNMENT SPONSORSHIP

This invention was made with government support under DE-AR0001395 awarded by the U.S. Department of Energy. The government has certain rights in the invention.

### TECHNICAL FIELD

Fluoride-containing ammonium salts and methods of production and uses thereof are generally described.

### SUMMARY

Disclosed herein are fluoride-containing salts and methods of production and uses thereof. For example, methods of producing ammonium fluoride by combining a material comprising a fluorosilicate with an amine are disclosed. In some cases, the method comprises producing ammonium bifluoride and ammonia from the produced ammonium fluoride, and further producing ammonium fluoride by combining a material comprising a fluorosilicate with an amine wherein the amine comprises the produced ammonia. In certain instances, the method comprises producing ammonium bifluoride from the produced ammonium fluoride without producing and/or accumulating a substantial net amount of hydrogen fluoride. In certain cases, the method further comprises combining the produced ammonium fluoride and/or ammonium bifluoride with a material comprising silicate to produce amorphous silicate and/or a salt. In some embodiments, the silicates and/or salts are suitable for use in cementitious materials. In certain embodiments, the material comprising silicates further comprises lithium, and the methods produce an amorphous silicate and a salt (e.g., a lithium salt, such as lithium fluoride, lithium carbonate, lithium hydroxide, and/or lithium chloride, and/or an aluminum salt, such as aluminum fluoride, ammonium hexafluoroaluminate, and/or an alkali (e.g., potassium and/or sodium and/or lithium) hexafluoroaluminate (cryolite)) and/or aluminum oxide and/or aluminum hydroxide. In certain embodiments, the material comprising a fluorosilicate comprises a waste product, such as a waste product from ore processing (e.g., phosphate ore processing), fertilizer production, and/or aluminum production and/or refinement. The subject matter of the present disclosure involves, in some cases, interrelated products, alternative solutions to a particular problem, and/or a plurality of different uses of one or more systems and/or articles.

Certain aspects relate to methods. In certain embodiments, the method comprises a) combining a material comprising a fluorosilicate with an amine to produce ammonium fluoride; b) producing ammonium bifluoride and ammonia from the produced ammonium fluoride; and c) repeating step a), wherein the amine comprises the ammonia produced in step b).

In some embodiments, the method comprises a) combining a material comprising a fluorosilicate with an amine to produce ammonium fluoride; and b) producing ammonium bifluoride from the produced ammonium fluoride, wherein step b) does not produce and/or accumulate a substantial net amount of hydrogen fluoride.

In certain embodiments, the method comprises a) combining a material comprising a fluorosilicate with an amine to produce ammonium fluoride and/or ammonium bifluoride; and b) combining the produced ammonium fluoride and/or ammonium bifluoride with a material comprising silicate to produce silicate and/or a salt.

Certain aspects relate to amorphous silicates. In some embodiments, the amorphous silicate comprises greater than or equal to 10 ppm and less than or equal to 20 wt. % fluoride.

Certain aspects relate to methods of producing a silicate (e.g., an amorphous silicate) and/or a salt. In certain embodiments, the method comprises combining ammonium fluoride and/or ammonium bifluoride with a material comprising silicate in an aqueous combination at a maximum temperature of greater than or equal to 10° C. and less than or equal to 125° C.; and producing amorphous silicate and/or a salt; wherein the method does not produce and/or accumulate a substantial net amount of hydrogen fluoride.

In some embodiments, the method comprises combining ammonium fluoride and/or ammonium bifluoride with a material comprising silicate in an anhydrous combination at a maximum temperature of greater than or equal to 160° C. and less than or equal to 250° C.; and producing amorphous silicate and/or a salt; wherein the method does not produce and/or accumulate a substantial net amount of hydrogen fluoride.

In certain embodiments, the method comprises combining ammonium fluoride and/or ammonium bifluoride with a material comprising silicate in an aqueous combination; and producing amorphous silicate and/or a salt; wherein the temperature of the material comprising silicate is at a maximum temperature of greater than or equal to 10° C. and less than or equal to 125° C. when the material comprising silicate contacts the ammonium fluoride and/or the ammonium bifluoride.

In some embodiments, the method comprises combining ammonium fluoride and/or ammonium bifluoride with a material comprising silicate in an anhydrous combination; and producing amorphous silicate and/or a salt; wherein the temperature of the material comprising silicate is at a maximum temperature of greater than or equal to 160° C. and less than or equal to 250° C. when the material comprising silicate contacts the ammonium fluoride and/or the ammonium bifluoride.

In certain embodiments, the method comprises combining ammonium fluoride and/or ammonium bifluoride with a material comprising silicate, wherein the material comprising silicate further comprises lithium; and producing a salt and an amorphous silicate; wherein the salt comprises a higher weight percentage of lithium than the material comprising silicate; and wherein the amorphous silicate comprises a lower weight percentage of lithium than the material comprising silicate.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows a method of producing a fluoride-containing ammonium salt, in accordance with some embodiments.

FIG. 2 shows possible pathways to hardened cement (calcium silicate hydrate, CSH), in accordance with some embodiments.

FIG. 3 shows a process of combining ammonium fluoride and/or ammonium bifluoride with a material comprising silicate to produce a product, in accordance with some embodiments.

FIG. 4 shows a method of producing a fluoride-containing ammonium salt from an acidic fluorosilicate, in accordance with some embodiments.

FIG. 5A shows a three-step process that generates amorphous SiO₂ from crystalline SiO₂, in accordance with some embodiments.

FIG. 5B shows a process of processing a lithium aluminosilicate, such as spodumene, in accordance with some embodiments.

FIG. 6A shows a process of producing various Li salts, in accordance with some embodiments.

FIG. 6B shows a process of isolating lithium as Li₂CO₃ by carbonating a Li-rich solution after recovering the fluorine, in accordance with some embodiments.

FIG. 6C shows a process for processing lepidolite, in accordance with some embodiments.

FIG. 7 shows a process of silicate subtraction that optionally includes a process for lithium recovery and/or a process for aluminum recovery, in accordance with some embodiments.

FIG. 8 shows a process for producing a silicate and/or a salt, in accordance with some embodiments.

FIG. 9 shows a system for chemical loop silica subtraction, in accordance with some embodiments.

FIG. 10 shows a photograph of amorphous SiO₂₍ₛ₎ generated from H₂SiF_{6(aq)} in Example 1.

FIG. 11 shows scanning electron microscopy (SEM) images of amorphous SiO₂₍ₛ₎ generated from H₂SiF_{6(aq)} in Example 1.

FIG. 12 shows electron dispersive spectroscopy (EDS) spectrum of amorphous SiO₂₍ₛ₎ generated from H₂SiF_{6(aq)}, in Example 1.

FIG. 13 shows scanning electron microscopy (SEM) images of ammonium fluoride (NH₄F) generated from H₂SiF_{6(aq)} in Example 1.

FIG. 14 shows the electron dispersive spectroscopy (EDS) spectrum of ammonium fluoride (NH₄F) generated from H₂SiF_{6(aq)} in Example 1.

FIG. 15A shows a process for converting non-pozzolanic silica to pozzolanic silica using ammonium bifluoride, in accordance with some embodiments.

FIG. 15B shows an illustration of a process for generating pozzolanic silica using the chemical loop process depicted in FIG. 15A, in accordance with some embodiments.

FIG. 15C shows coal combustion products (CCPs) supply and usage vs. time, reproduced from American Coal Ash Society Production Use and Reports (1991-2020).

FIG. 16A shows scanning electron microscopy (SEM) images of crystalline quartz sand before (top) and after (bottom) being subjected to the process described in FIG. 15A.

FIG. 16B shows X-ray diffraction analysis (XRD) of crystalline quartz sand before (top) and after (bottom) being subjected to the process described in FIG. 15A. The broad peak at 20-25° is indicative of amorphous silica.

FIG. 17 shows a process used on technical-grade (99.5% 400 mesh) silica, SEM images of the silica (before and after the process), and a photo of the SiO₂-depleted residue. SEM analysis of the SiO₂-depleted residue suggested a composition of mostly Fe and 0.

FIG. 18 shows the SEM-EDS map of the SiO₂-depleted residue after treatment of kaolinite with a silicate subtraction process, in accordance with some embodiments, which is consistent with the XRD identification of the crystalline phase as (NH₄)₃AlF₆.

FIG. 19 shows the XRD of kaolinite (top), the basified filtrate (middle), and the SiO₂-depleted residue (bottom) after treatment with a silicate subtraction process, in accordance with some embodiments. The XRD indicated total conversion of kaolinite to (NH₄)₃AlF₆ and SiO₂.

FIG. 20 shows the SEM-EDS map of the SiO₂-depleted residue after treatment of montmorillonite with a silicate subtraction process, in accordance with some embodiments. No Si signal was observed, indicating near total removal of Si which is consistent with the SiO₂ yield.

FIG. 21 shows the XRD of montmorillonite (top), the basified filtrate (middle), and the SiO₂-depleted residue (bottom) after treatment with a silicate subtraction process, in accordance with some embodiments. The XRD of the insoluble fraction indicated that (NH₄)₃AlF₆ is the dominant species with a small fraction of montmorillonite remaining.

FIG. 22 shows the SEM-EDS map of the SiO₂-depleted residue after treatment of olivine with a silicate subtraction process, in accordance with some embodiments.

FIG. 23 shows the XRD of olivine (top), the basified filtrate (middle), and the SiO₂-depleted residue (bottom) after treatment with a silicate subtraction process, in accordance with some embodiments. The XRD indicated a small fraction of olivine remaining in the insoluble fraction.

FIG. 24 shows the SEM-EDS map of the SiO₂-depleted residue after treatment of wollastonite with a silicate subtraction process, in accordance with some embodiments. No Si signal was observable in the SEM-EDS map of the insoluble fraction.

FIG. 25 shows the XRD of wollastonite (top), the basified filtrate (middle), and the SiO₂-depleted residue (bottom) after treatment with a silicate subtraction process, in accordance with some embodiments. The XRD indicated total dissolution of Si from the wollastonite.

FIG. 26 shows the XRD of basalt rock (top), the basified filtrate (middle), and the SiO₂-depleted residue (bottom) after treatment with a silicate subtraction process, in accordance with some embodiments. The red coloration of the insoluble residue was consistent with the Fe observed in the EDS map.

FIG. 27 shows the SEM-EDS map of the SiO₂-depleted residue after treatment of basalt rock with a silicate subtraction process, in accordance with some embodiments. Trace quantities of Si were observable in the insoluble residue, and Na, Mg, Ca, Fe, and F were also present.

FIG. 28 shows the XRD of ponded ash (top), the basified filtrate (middle), and the SiO₂-depleted residue (bottom) after treatment with a silicate subtraction process, in accordance with some embodiments. The XRD pattern was assigned to (NH₄)₃AlF₆, with no other prominent signals present.

FIG. 29 shows the SEM-EDS map of the SiO₂-depleted residue after treatment of ponded ash with a silicate subtraction process, in accordance with some embodiments. No signal for Si was observable, and both Mg and Ca signals were present.

FIG. 30 shows the XRD of bottom ash (top), the basified filtrate (middle), and the SiO₂-depleted residue (bottom) after treatment with a silicate subtraction process, in accordance with some embodiments. Trace quantities of unidentified compounds were observed in the soluble residue. The highest intensity signal was assigned to (NH₄)₃AlF₆.

FIG. 31 shows the SEM-EDS map of the SiO₂-depleted residue after treatment of bottom ash with a silicate subtraction process, in accordance with some embodiments. Trace quantities of Si were observable in the insoluble residue.

FIG. 32 shows the XRD spectrum of silica generated, with an internal Si powder reference. The broad peak with a maximum in the 20-25 range is characteristic of amorphous silica.

FIG. 33 shows a system used to detect HF. The system comprised wet fluoride ion detection paper (pink) suspended above a boiling solution (500 mL, T_{bath}=125° C.) of ammonium bifluoride (10 g) and a silica suspension (1 g). No HF was detectable by fluoride ion indicator paper suspended above a boiling solution of NH₄F for ~5 h, with a ~150 mL reduction in solution volume. The presence of fluoride ions would result in a yellow coloration on the detection paper. The absence of yellow coloration indicated no appreciable amount of HF emanated from the solution.

FIG. 34 shows the ¹⁹F NMR spectrum of a solution of NH₄F/NH₄HF₂ heated to a boil in a 125° C. oil bath over the course of 4 h, referenced vs. an internal CH₂FCN standard (~251 ppm). The expected position of aqueous HF is −204 ppm vs. the internal standard.

FIG. 35 shows the particle size distribution of pozzolanic silica obtained for fast NH₃ titration and slow NH₃ fumigation.

FIGS. 36A-36B shows SEM images of the silicate produced with different NH₄OH titration times.

FIG. 37 plots the particle size distribution of pozzolanic silica produced with different NH₄OH titration rates.

FIG. 38 shows SEM images of the silica starting material and precipitated silica collected from the filtrate after ammonium bifluoride treatment.

FIG. 39 shows a process for converting non-pozzolanic (crystalline) silica to pozzolanic (amorphous) silica using ammonium bifluoride, in accordance with some embodiments.

FIG. 40 shows a photo, XRD, and SEM-EDS of the silica product obtained from quartz sand. The results show that the silica product obtained was similar in structure to silica fume.

FIG. 41 shows DOR* calorimetry results (left) for the silica product obtained from quartz sand and a photo (right) of vials of pozzolanic cement made from the silica product obtained from quartz sand after curing at 50° C. for 48 hours.

FIG. 42 shows DOR* TGA (thermogravimetric analysis) measurements, showing that ~184 g of Ca(OH)₂ were consumed per 100 g of pozzolan cement produced from the silica product obtained from quartz sand.

FIG. 43 shows calorimetry and TGA data demonstrating that the silica product obtained from quartz sand had a reactivity comparable to that of fumed silica.

FIG. 44 shows the reactivity of the generated pozzolanic silica (“SynPozz”) versus other pozzolans using Pozzolanic Reactivity Testing (PRT), demonstrating that the generated pozzolanic silica (“SynPozz”) had the highest reactivity. Densified and undensified silica refer to fumed silica with different tap density and aggregate particle size.

FIG. 45 shows BET analysis of the generated pozzolanic silica (“SynPozz”) versus other pozzolans, demonstrating that the generated pozzolanic silica (“SynPozz”) had a higher surface area than undensified silica fume. This was measured according to ASTM C1069-09 (Alumina and Quartz BET Surface Area). Densified and undensified silica refer to fumed silica with different tap density and aggregate particle size.

FIG. 46 plots the calcium hydroxide (“CH”) consumed (g/100 g SCM) during a standard pozzolanic reactivity test (which is a measure of reactivity) versus the market price ($/ton).

FIG. 47 shows an SEM image of a spodumene starting reagent.

FIG. 48 shows scanning electron microscopy energy-dispersive spectroscopy (SEM-EDS) analysis that shows that the spodumene starting material had 90% spodumene and 10% silica.

FIG. 49 shows XRD analysis of the spodumene starting material phases, which shows that 90% is LiSi₂AlO₆ and 10% is SiO₂. The phase (by XRD Rietveld analysis) was SiO₂:LiAl(SiO₃)₂, 10:90.

FIG. 50 plots lithium extraction (%) from spodumene versus time (hours), as tracked from ⁷Li-NMR.

FIG. 51 shows ⁷Li NMR of the reaction mixture over time during spodumene digestion in 3M NH₄HF₂, which shows that lithium readily dissolved.

FIG. 52 plots lithium concentration (M) versus reaction time (hours) during spodumene digestion in 3M NH₄HF₂.

FIG. 53 shows an x-ray diffraction (XRD) and SEM-EDS of LiF isolated from spodumene. The silica impurity was from residual precipitate from the previous step.

FIG. 54 plots normalized ⁷Li signal (a.u.) versus time (hours), demonstrating that Li⁺ can be leached from lepidolite, in accordance with some embodiments.

FIG. 55 shows 5.00 g of lepidolite before treatment with ammonium bifluoride (pre-digest) (left) and 2.546 g of lepidolite after treatment with ammonium bifluoride (post-digest) (right).

FIG. 56 shows an XRD overlay of lepidolite before treatment with ammonium bifluoride (pre-digest) and lepidolite after treatment with ammonium bifluoride (post-digest). The XRD suggests that the remaining solid fraction after lepidolite digestion was composed of the potassium (K₃AlF₆) and ammonium salt ((NH₄)₃AlF₆) of hexafluoroaluminate.

FIG. 57 shows an XRD assignable to (NH₄)₂SiF₆ with an amorphous SiO₂ peak present from lepidolite digestion.

FIG. 58 shows SEM-EDS of lepidolite before treatment with ammonium bifluoride (pre-digest) (left) and lepidolite after treatment with ammonium bifluoride (post-digest) (right). The EDS of the pre-digest lepidolite detected elements: Na, K, Al, Si, and O. The EDS of the post-digest lepidolite detected elements: Na, K, Al, O, F, and N. The SEM-EDS suggested that the remaining solid fraction after lepidolite digestion was composed of various hexafluoroaluminate salts.

FIG. 59 shows a photo of pozzolanic SiO₂ isolated from the soluble fraction after lepidolite treatment with ammonium bifluoride, with contamination of unhydrolyzed SiF₆²⁻.

### DETAILED DESCRIPTION

Disclosed herein are fluoride-containing salts and methods of production and uses thereof. For example, methods of producing ammonium fluoride by combining a material comprising a fluorosilicate with an amine are disclosed. In some cases, the method comprises producing ammonium bifluoride and ammonia from the produced ammonium fluoride, and further producing ammonium fluoride by combining a material comprising a fluorosilicate with an amine, wherein the amine comprises the produced ammonia. In certain instances, the method comprises producing ammonium bifluoride from the produced ammonium fluoride without producing and/or accumulating a substantial net amount of hydrogen fluoride. In certain cases, the method further comprises combining the produced ammonium fluoride and/or ammonium bifluoride with a material comprising silicate to produce amorphous silicate and/or a salt. In some embodiments, the silicates and/or salts are suitable for use in cementitious materials. In certain embodiments, the material comprising silicates further comprises lithium, and the methods produce an amorphous silicate and a salt (e.g., a lithium salt, such as lithium fluoride, lithium carbonate, lithium hydroxide, and/or lithium chloride, and/or an aluminum salt, such as aluminum fluoride, ammonium hexafluoroaluminate, and/or an alkali (e.g., potassium and/or sodium and/or lithium) hexafluoroaluminate (cryolite)) and/or aluminum oxide and/or aluminum hydroxide. In certain embodiments, the material comprising a fluorosilicate comprises a waste product, such as a waste product from ore processing (e.g., phosphate ore processing), fertilizer production, and/or aluminum production and/or refinement.

Certain aspects are related to methods.

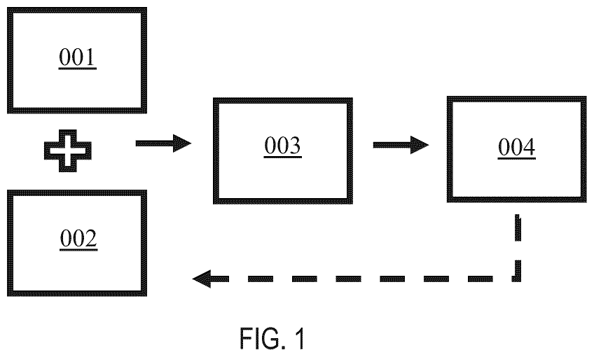

In some embodiments, the method comprises combining a material comprising a fluorosilicate with an amine to produce ammonium fluoride and/or ammonium bifluoride. For example, in FIG. 1, in some cases, the method comprises combining material comprising a fluorosilicate 001 with amine 002 to produce fluoride-containing ammonium salt 003 (e.g., ammonium fluoride and/or ammonium bifluoride). In certain instances, the method comprises combining a material comprising a fluorosilicate with an amine to produce ammonium fluoride. For example, in FIG. 1, in some embodiments, fluoride-containing ammonium salt 003 comprises ammonium fluoride. In some cases, combining the material comprising a fluorosilicate with an amine to produce ammonium fluoride further produces ammonium bifluoride. For example, in some instances, the method comprises combining a material comprising a fluorosilicate with an amine to produce ammonium fluoride and ammonium bifluoride. For example, in FIG. 1, in certain embodiments, fluoride-containing ammonium salt 003 comprises ammonium fluoride and ammonium bifluoride.

In accordance with some embodiments, combining the material comprising a fluorosilicate with an amine to produce ammonium fluoride (and/or ammonium bifluoride) comprises combining the material comprising a fluorosilicate with an amine to produce ammonium fluoride (and/or ammonium bifluoride) in a fluid at a temperature and at a maximum pressure of the mixture.

In certain embodiments, the temperature of the mixture when the material comprising a fluorosilicate is combined with the amine in a fluid is greater than the freezing point of the fluid. In some embodiments, the temperature of the mixture when the material comprising a fluorosilicate is combined with the amine in a fluid is less than the boiling point of the fluid. Combinations of these ranges are also possible (e.g., greater than the freezing point of the fluid and less than the boiling point of the fluid).

In some embodiments, the temperature of the mixture when the material comprising a fluorosilicate is combined with the amine is greater than or equal to −10° C., greater than or equal to 0° C., greater than or equal to 1° C., greater than or equal to 5° C., greater than or equal to 10° C., greater than or equal to 15° C., greater than or equal to 20° C., greater than or equal to 25° C., greater than or equal to 30° C., greater than or equal to 40° C., greater than or equal to 50° C., greater than or equal to 60° C., greater than or equal to 70° C., greater than or equal to 80° C., or greater than or equal to 90° C. According to certain embodiments, the temperature of the mixture when the material comprising a fluorosilicate is combined with the amine is less than or equal to 150° C., less than or equal to 140° C., less than or equal to 125° C., less than or equal to 120° C., less than or equal to 115° C., less than or equal to 110° C., less than or equal to 105° C., less than or equal to 100° C., less than or equal to 95° C., less than or equal to 90° C., less than or equal to 80° C., less than or equal to 70° C., less than or equal to 60° C., or less than or equal to 50° C. Combinations of these ranges are also possible (e.g., greater than or equal to −10° C. and less than or equal to 150° C., greater than or equal to 0° C. and less than or equal to 125° C., greater than or equal to 10° C. and less than or equal to 125° C., greater than or equal to 0° C. and less than or equal to 50° C., or greater than or equal to 30° C. and less than or equal to 125° C.).

In some embodiments, the maximum pressure of the mixture when the material comprising a fluorosilicate is combined with the amine is less than or equal to 100 atm, less than or equal to 90 atm, less than or equal to 80 atm, less than or equal to 70 atm, less than or equal to 60 atm, less than or equal to 50 atm, less than or equal to 40 atm, less than or equal to 30 atm, less than or equal to 20 atm, less than or equal to 10 atm, less than or equal to 5 atm, or less than or equal to 1 atm. In certain instances, the maximum pressure of the mixture when the material comprising a fluorosilicate is combined with the amine is greater than or equal to 0.1 atm, greater than or equal to 0.5 atm, greater than or equal to 1 atm, greater than or equal to 2 atm, greater than or equal to 3 atm, greater than or equal to 5 atm, greater than or equal to 10 atm, or greater than or equal to 20 atm. Combinations of these ranges are also possible (e.g., greater than or equal to 0.1 atm and less than or equal to 100 atm, greater than or equal to 1 atm and less than or equal to 100 atm, or greater than or equal to 1 atm and less than or equal to 10 atm). In accordance with some embodiments, the maximum pressure of the mixture when the material comprising a fluorosilicate is combined with the amine is 1 atm.

As used herein, maximum pressure is measured as an absolute pressure.

In accordance with certain embodiments, combining the material comprising a fluorosilicate with the amine to produce ammonium fluoride (and/or ammonium bifluoride) results in hydrolysis of at least a portion of the fluorosilicate. For example, in some cases, combining the material comprising a fluorosilicate with the amine to produce ammonium fluoride (and/or ammonium bifluoride) results in hydrolysis of greater than or equal to 1 wt %, greater than or equal to 5 wt %, greater than or equal to 10 wt %, greater than or equal to 15 wt %, greater than or equal to 25 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %, greater than or equal to 97 wt %, greater than or equal to 99 wt %, or greater than or equal to 99.9 wt % of the fluorosilicate. According to certain embodiments, combining the material comprising a fluorosilicate with the amine to produce ammonium fluoride (and/or ammonium bifluoride) results in hydrolysis of less than or equal to 100 wt %, less than or equal to 99.9 wt %, less than or equal to 99 wt %, less than or equal to 97 wt %, less than or equal to 95 wt %, less than or equal to 90 wt %, less than or equal to 85 wt %, less than or equal to 80 wt %, or less than or equal to 75 wt % of the fluorosilicate. Combinations of the above-referenced ranges are also possible (e.g., greater than or equal to 1 wt % and less than or equal to 100 wt %, greater than or equal to 25 wt % and less than or equal to 100 wt %, greater than or equal to 99 wt % and less than or equal to 100 wt %, or greater than or equal to 99.9 wt % and less than or equal to 100 wt %). In some instances, combining the material comprising a fluorosilicate with the amine to produce ammonium fluoride (and/or ammonium bifluoride) results in 100 wt % hydrolysis of the fluorosilicate. In some embodiments, hydrolysis of the fluorosilicate comprises silicon-fluorine bond breakage with subsequent formation of silicon-oxygen bonds.

In certain embodiments, the hydrolyzed material is separated (e.g., filtered) from the hydrolysis medium following hydrolysis. In some cases, the hydrolyzed material comprises silicate (e.g., amorphous and/or crystalline silicate) (e.g., any silicate disclosed herein), ammonium fluoride, and/or ammonium bifluoride.

In accordance with certain embodiments, combining the material comprising a fluorosilicate with the amine to produce ammonium fluoride (and/or ammonium bifluoride) further produces ammonium hexafluorosilicate.

According to some embodiments, the material comprising a fluorosilicate comprises an acidic fluorosilicate. In certain embodiments, the acidic fluorosilicate comprises hexafluorosilicic acid (H₂SiF₆). In some instances, the material comprising a fluorosilicate comprises a waste product. In some embodiments, the waste product comprises a waste product from ore processing (e.g., phosphate ore processing), fertilizer production, and/or aluminum production and/or refinement. In certain embodiments, the material comprising a fluorosilicate and/or the acidic fluorosilicate is in the form of a gas, liquid, solid, or a mixture of two or more of these.

In accordance with some embodiments, the material comprising a fluorosilicate comprises greater than or equal to 1 wt %, greater than or equal to 5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt % of the fluorosilicate. In certain cases, the material comprising a fluorosilicate comprises less than or equal to 99.9 wt %, less than or equal to 99 wt %, less than or equal to 98 wt %, less than or equal to 95 wt %, less than or equal to 90 wt %, less than or equal to 85 wt %, less than or equal to 80 wt %, less than or equal to 70 wt %, less than or equal to 60 wt %, less than or equal to 50 wt %, less than or equal to 40 wt %, or less than or equal to 30 wt % of the fluorosilicate. Combinations of these ranges are also possible (e.g., greater than or equal to 1 wt % and less than or equal to 99.9 wt % or greater than or equal to 20 wt % and less than or equal to 99.9 wt %).

According to certain embodiments, the amine is in the form of a liquid, solid, gas, and/or solution. In some embodiments, different forms of the amine (e.g., a liquid, solid, gas, and/or solution) are selected for different operation conditions. For example, in certain cases, a form of the amine (e.g., a liquid, solid, gas, and/or solution) is selected for the operation conditions.

In certain embodiments, the amine comprises an inorganic amine. In some cases, the inorganic amine comprises ammonia.

In some embodiments, the amine comprises an organic amine. In certain instances, the organic amine comprises trimethylamine, triethylamine, tripropylamine, tributylamine, and/or pyridine.

According to some embodiments, the ammonium fluoride and/or ammonium bifluoride comprises low levels of impurities. For example, in certain embodiments, the ammonium fluoride and/or ammonium bifluoride comprises less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 7 wt %, less than or equal to 5 wt %, less than or equal to 3 wt %, less than or equal to 1 wt %, less than or equal to 0.5 wt %, or less than or equal to 0.1 wt % of total impurities or of an individual impurity. In some embodiments, the ammonium fluoride and/or ammonium bifluoride comprises greater than or equal to 0 wt %, greater than or equal to 0.000001 wt %, greater than or equal to 0.00001 wt %, greater than or equal to 0.0001 wt %, greater than or equal to 0.001 wt %, greater than or equal to 0.01 wt %, greater than or equal to 0.1 wt %, greater than or equal to 0.2 wt %, greater than or equal to 0.3 wt %, or greater than or equal to 0.5 wt % of total impurities or of an individual impurity. Combinations of these ranges are also possible (e.g., greater than or equal to 0 wt % and less than or equal to 90 wt %, greater than or equal to 0 wt % and less than or equal to 20 wt %, greater than or equal to 0 wt % and less than or equal to 5 wt %, greater than or equal to 0.000001 wt % and less than or equal to 20 wt %, or greater than or equal to 0.000001 wt % and less than or equal to 5 wt %). In some embodiments, the ammonium fluoride and/or ammonium bifluoride comprises 0 wt % of total impurities or of an individual impurity.

As used herein, an “impurity” with respect to a particular substance in solid form means any material other than the substance itself. For example, in the case of solid ammonium fluoride, an impurity is any substance other than ammonium fluoride. An “impurity” with respect to a particular substance that is solubilized in a solution means any material other than the substance that has been solubilized and the solvent(s) within the solution. For example, in the case of an aqueous ammonium fluoride solution, an impurity would be any substance present in the solution other than the ammonium fluoride and the aqueous solvent.

According to some embodiments, the ammonium fluoride and/or ammonium bifluoride comprises low levels of silicon. For example, in certain embodiments, the ammonium fluoride and/or ammonium bifluoride comprises less than or equal to 20 wt %, less than or equal to 15 wt %, less than or equal to 10 wt %, less than or equal to 7 wt %, less than or equal to 5 wt %, less than or equal to 3 wt %, or less than or equal to 1 wt % silicon. In some embodiments, the ammonium fluoride and/or ammonium bifluoride comprises greater than or equal to 0 wt %, greater than or equal to 0.000001 wt %, greater than or equal to 0.00001 wt %, greater than or equal to 0.0001 wt %, greater than or equal to 0.001 wt %, greater than or equal to 0.01 wt %, greater than or equal to 0.1 wt %, greater than or equal to 0.2 wt %, greater than or equal to 0.3 wt %, greater than or equal to 0.5 wt %, greater than or equal to 1 wt %, greater than or equal to 2 wt %, or greater than or equal to 3 wt % silicon. Combinations of these ranges are also possible (e.g., greater than or equal to 0 wt % and less than or equal to 20 wt %, greater than or equal to 0 wt % and less than or equal to 10 wt %, greater than or equal to 0 wt % and less than or equal to 5 wt %, greater than or equal to 0 wt % and less than or equal to 1 wt %, greater than or equal to 0.000001 wt % and less than or equal to 20 wt %, greater than or equal to 0.000001 wt % and less than or equal to 10 wt %, greater than or equal to 0.000001 wt % and less than or equal to 20 wt %, greater than or equal to 0.000001 wt % and less than or equal to 10 wt %, or greater than or equal to 0.000001 wt % and less than or equal to 5 wt %, greater than or equal to 0.000001 wt % and less than or equal to 1 wt %). In some embodiments, the ammonium fluoride and/or ammonium bifluoride comprises 0 wt % silicon.

According to certain embodiments, the ammonium fluoride and/or ammonium bifluoride is of suitable purity for use as an ore processing reagent.

In accordance with some embodiments, the method comprises producing ammonium bifluoride from the produced ammonium fluoride. For example, in FIG. 1, in some cases, the method comprises producing product 004 (e.g., ammonium bifluoride) from fluoride-containing ammonium salt 003 (e.g., ammonium fluoride). In some embodiments, producing ammonium bifluoride from the produced ammonium fluoride also produces ammonia. For example, in some cases, the method comprises producing ammonium bifluoride and ammonia from the produced ammonium fluoride. For example, in FIG. 1, in some cases, the method comprises producing product 004 (e.g., ammonium bifluoride and ammonia) from fluoride-containing ammonium salt 003 (e.g., ammonium fluoride). In certain instances, the method comprises further producing ammonium fluoride by combining a material comprising a fluorosilicate with an amine, wherein the amine comprises the produced ammonia. For example, in certain embodiments, the method comprises repeating a step (e.g., combining a material comprising a fluorosilicate with an amine to produce ammonium fluoride and/or combining a material comprising a fluorosilicate with an amine to produce ammonium fluoride and/or ammonium bifluoride), wherein the amine comprises the produced ammonia. For example, in FIG. 1, in some cases, the method optionally comprises repeating the step of combining material comprising a fluorosilicate 001 with amine 002 to produce fluoride-containing ammonium salt 003 (e.g., ammonium fluoride and/or ammonium bifluoride), wherein amine 002 comprises product 004 or a portion thereof (e.g., ammonia).

According to some embodiments, the method comprises further combining a material comprising a fluorosilicate with an amine to produce ammonium fluoride (or ammonium fluoride and/or ammonium bifluoride), wherein the amine comprises the produced ammonia. For example, in some cases, the amine (e.g., when further combining a material comprising a fluorosilicate with an amine to produce ammonium fluoride (or ammonium fluoride and/or ammonium bifluoride)) comprises greater than or equal to 10 wt %, greater than or equal to 20 wt %, greater than or equal to 30 wt %, greater than or equal to 40 wt %, or greater than or equal to 50 wt % of the produced ammonia. In certain instances, the amine (e.g., when further combining a material comprising a fluorosilicate with an amine to produce ammonium fluoride (or ammonium fluoride and/or ammonium bifluoride)) comprises less than or equal to 100 wt %, less than or equal to 90 wt %, less than or equal to 80 wt %, less than or equal to 70 wt %, or less than or equal to 60 wt % of the produced ammonia. Combinations of these ranges are also possible (e.g., greater than or equal to 10 wt % and less than or equal to 100 wt % or greater than or equal to 40 wt % and less than or equal to 60 wt %). According to certain embodiments, the amine (e.g., when further combining a material comprising a fluorosilicate with an amine to produce ammonium fluoride (or ammonium fluoride and/or ammonium bifluoride)) comprises 100 wt % of the produced ammonia.

In accordance with certain embodiments, the method comprises additional downstream steps that produce ammonia, such that the amine (e.g., when further combining a material comprising a fluorosilicate with an amine to produce ammonium fluoride (or ammonium fluoride and/or ammonium bifluoride)) comprises greater than or equal to 80 wt %, greater than or equal to 90 wt %, or 100 wt % ammonia produced in the method (e.g., in a downstream step and/or produced from the ammonium fluoride).

In certain embodiments, producing ammonium bifluoride from the produced ammonium fluoride does not produce and/or accumulate a substantial net amount of hydrogen fluoride (e.g., as disclosed elsewhere herein). For example, in FIG. 1, in some cases, producing product 004 (e.g., ammonium bifluoride) from fluoride-containing ammonium salt 003 (e.g., ammonium fluoride) does not produce and/or accumulate a substantial net amount of hydrogen fluoride. For example, in some cases, producing ammonium bifluoride and ammonia from the produced ammonium fluoride does not produce and/or accumulate a substantial net amount of hydrogen fluoride (e.g., as disclosed elsewhere herein). For example, in FIG. 1, in some cases, producing product 004 (e.g., ammonium bifluoride and ammonia) from fluoride-containing ammonium salt 003 (e.g., ammonium fluoride) does not produce and/or accumulate a substantial net amount of hydrogen fluoride.

In some embodiments, combining the material comprising a fluorosilicate with ammonia to produce ammonium fluoride further produces a silicate (e.g., any silicate disclosed herein).

In certain embodiments, the method comprises combining the produced ammonium fluoride and/or ammonium bifluoride with a material comprising silicate (e.g., any material comprising silicate disclosed herein) to produce silicate (e.g., ammonium hexafluorosilicate) (e.g., any silicate disclosed herein) and/or a salt (e.g., any salt disclosed herein) (e.g., lithium fluoride). For example, in FIG. 1, in some cases, the method comprises combining material comprising a fluorosilicate 001 with amine 002 to produce fluoride-containing ammonium salt 003 (e.g., ammonium fluoride and/or ammonium bifluoride) and producing product 004 (e.g., a silicate and/or a salt) from fluoride-containing ammonium salt 003 (e.g., ammonium fluoride and/or ammonium bifluoride).

In some embodiments, the silicate comprises an amorphous silicate. In certain cases, the amorphous silicate has physical and chemical characteristics that satisfy the criteria of ASTM C618-84. In some instances, the amorphous silicate has physical and chemical characteristics that satisfy the criteria of ASTM C1240-20.

According to certain embodiments, the silicate is suitable for use in cementitious materials.

In accordance with some embodiments, the method comprises separating (e.g., filtering) a solid from a liquid (e.g., before or after any method step described herein). In certain cases, the method comprises a drying and/or precipitation step (e.g., before or after any method step described herein).

Certain aspects are related to silicates.

The silicate can comprise silicon and an anion containing oxygen. In some instances, the silicate comprises silicon and an anion containing oxygen and no other anions. For example, in some cases, the silicate comprises silica.

In some embodiments, the silicate comprises an amorphous silicate. A silicate is amorphous when it is non-crystalline. In some cases, a silicate that is amorphous has a full width at half maximum (FWHM) X-ray diffraction peak originating from silica (20=20-25 degrees) that has a 20 value of greater than or equal to 8.0±2.5 degrees.

According to certain embodiments, the silicate comprises a pozzolanic silicate. In some embodiments, a material is pozzolanic if it will, when in finely divided form and in the presence of moisture, chemically react with a source of calcium (e.g., calcium hydroxide) to form compounds having cementitious properties.

In some embodiments, the silicate (e.g., amorphous silicate) comprises fluoride. For example, in certain embodiments, the silicate (e.g., amorphous silicate) comprises greater than or equal to 10 ppm, greater than or equal to 20 ppm, greater than or equal to 30 ppm, greater than or equal to 40 ppm, greater than or equal to 50 ppm, greater than or equal to 75 ppm, greater than or equal to 100 ppm, greater than or equal to 125 ppm, greater than or equal to 150 ppm, greater than or equal to 175 ppm, or greater than or equal to 200 ppm fluoride. In some embodiments, the silicate (e.g., amorphous silicate) comprises less than or equal to 20 wt. %, less than or equal to 15 wt. %, less than or equal to 10 wt. %, less than or equal to 5 wt. %, less than or equal to 1 wt. %, less than or equal to 0.5 wt. %, less than or equal to 1000 ppm, less than or equal to 750 ppm, less than or equal to 500 ppm, less than or equal to 250 ppm fluoride, or less than or equal to 100 ppm fluoride. Combinations of these ranges are also possible (e.g., greater than or equal to 10 ppm and less than or equal to 20 wt. % fluoride or greater than or equal to 10 ppm and less than or equal to 250 ppm fluoride). As used herein, “ppm” refers to parts per million (by weight), unless indicated otherwise.

In certain embodiments, the silicate (e.g., amorphous silicate) has a suitable distribution of particle diameters. For example, in some embodiments, the silicate (e.g., amorphous silicate) has a suitable distribution of particle diameters for use in cementitious materials. For example, according to some embodiments, the silicate (e.g., amorphous silicate) has a distribution of particle diameters of greater than or equal to 0.01 microns, greater than or equal to 0.05 microns, greater than or equal to 0.1 microns, greater than or equal to 0.3 microns, greater than or equal to 0.5 microns, greater than or equal to 1 micron, greater than or equal to 2 microns, greater than or equal to 3 microns, greater than or equal to 5 microns, greater than or equal to 7 microns, or greater than or equal to 10 microns. In accordance with certain embodiments, the silicate (e.g., amorphous silicate) has a distribution of particle diameters of less than or equal to 20 microns, less than or equal to 18 microns, less than or equal to 15 microns, less than or equal to 10 microns, less than or equal to 8 microns, less than or equal to 5 microns, less than or equal to 3 microns, or less than or equal to 2 microns. Combinations of these ranges are also possible (e.g., greater than or equal to 0.01 microns and less than or equal to 20 microns or greater than or equal to 0.5 microns and less than or equal to 20 microns). Particle size and particle size distribution may be determined using a laser diffraction particle size analyzer.

According to some embodiments, the silicate (e.g., amorphous silicate) has a suitable tap density. For example, in certain embodiments, the silicate (e.g., amorphous silicate) has a suitable tap density for use in cementitious materials. For example, in certain cases, the silicate (e.g., amorphous silicate) has a tap density of greater than or equal to 0.1 g/cm³, greater than or equal to 0.2 g/cm³, greater than or equal to 0.3 g/cm³, greater than or equal to 0.4 g/cm³, greater than or equal to 0.5 g/cm³, greater than or equal to 0.7 g/cm³, or greater than or equal to 1.0 g/cm³. In some instances, the silicate (e.g., amorphous silicate) has a tap density of less than or equal to 2.0 g/cm³, less than or equal to 1.9 g/cm³, less than or equal to 1.8 g/cm³, less than or equal to 1.7 g/cm³, less than or equal to 1.6 g/cm³, or less than or equal to 1.5 g/cm³. Combinations of these ranges are also possible (e.g., greater than or equal to 0.1 g/cm³ and less than or equal to 2.0 g/cm³, greater than or equal to 0.2 g/cm³ and less than or equal to 1.9 g/cm³, greater than or equal to 0.3 g/cm³ and less than or equal to 1.8 g/cm³, greater than or equal to 0.5 g/cm³ and less than or equal to 1.8 g/cm³, or greater than or equal to 1.0 g/cm³ and less than or equal to 1.8 g/cm³).

In accordance with some embodiments, the silicate (e.g., amorphous silicate) has a suitable specific surface area (SSA). For example, in certain embodiments, the silicate (e.g., amorphous silicate) has a suitable specific surface area (SSA) for use in cementitious materials. For example, in certain embodiments, the silicate (e.g., amorphous silicate) has an SSA of greater than or equal to 1 m²/g, greater than or equal to 2 m²/g, greater than or equal to 5 m²/g, greater than or equal to 10 m²/g, greater than or equal to 15 m²/g, greater than or equal to 20 m²/g, greater than or equal to 25 m²/g, greater than or equal to 30 m²/g, greater than or equal to 35 m²/g, greater than or equal to 40 m²/g, greater than or equal to 50 m²/g, greater than or equal to 60 m²/g, greater than or equal to 75 m²/g, or greater than or equal to 100 m²/g. According to some embodiments, the silicate (e.g., amorphous silicate) has an SSA of less than or equal to 2000 m²/g, less than or equal to 1900 m²/g, less than or equal to 1800 m²/g, less than or equal to 1700 m²/g, less than or equal to 1600 m²/g, less than or equal to 1500 m²/g, less than or equal to 1400 m²/g, less than or equal to 1300 m²/g, less than or equal to 1200 m²/g, less than or equal to 1100 m²/g, less than or equal to 1000 m²/g, less than or equal to 900 m²/g, less than or equal to 800 m²/g, less than or equal to 700 m²/g, less than or equal to 600 m²/g, less than or equal to 500 m²/g, less than or equal to 400 m²/g, less than or equal to 300 m²/g, less than or equal to 200 m²/g, less than or equal to 100 m²/g, less than or equal to 90 m²/g, less than or equal to 80 m²/g, less than or equal to 70 m²/g, less than or equal to 60 m²/g, or less than or equal to 50 m²/g. Combinations of these ranges are also possible (e.g., greater than or equal to 1 m²/g and less than or equal to 2000 m²/g, greater than or equal to 1 m²/g and less than or equal to 1000 m²/g, greater than or equal to 1 m²/g and less than or equal to 100 m²/g, greater than or equal to 2 m²/g and less than or equal to 50 m²/g, greater than or equal to 5 m²/g and less than or equal to 20 m²/g, greater than or equal to 35 m²/g and less than or equal to 100 m²/g, or greater than or equal to 40 m²/g and less than or equal to 100 m²/g). The SSA may be measured according to the Brunauer-Emmett-Teller (BET) method.

In certain embodiments, the silicate (e.g., amorphous silicate) comprises metals (e.g., an amount of metals—total metals and/or individual metals—suitable for use in cementitious materials). For example, in some cases, the silicate (e.g., amorphous silicate) comprises greater than or equal to 1000 ppm, greater than or equal to 2000 ppm, greater than or equal to 3000 ppm, greater than or equal to 4000 ppm, greater than or equal to 5000 ppm, greater than or equal to 6000 ppm, greater than or equal to 7000 ppm, greater than or equal to 8000 ppm, or greater than or equal to 9000 ppm metals (e.g., of total metals and/or of an individual metal). According to some embodiments, the silicate (e.g., amorphous silicate) comprises less than or equal to 10,000 ppm, less than or equal to 9000 ppm, less than or equal to 8000 ppm, less than or equal to 7000 ppm, less than or equal to 6000 ppm, less than or equal to 5000 ppm, less than or equal to 4000 ppm, less than or equal to 3000 ppm, or less than or equal to 2000 ppm metals (e.g., of total metals and/or of an individual metal). Combinations of these ranges are also possible (e.g., greater than or equal to 1000 ppm and less than or equal to 10,000 ppm metals).

In some embodiments, the silicate (e.g., amorphous silicate) has a suitable Degree of Reactivity (DOR*). For example, in certain cases, the silicate (e.g., amorphous silicate) has a suitable Degree of Reactivity (DOR*) for use in cementitious materials. In certain instances, the Degree of Reactivity (DOR*) of a material (e.g., silicate) is the theoretical maximum mass fraction of the material (e.g., silicate) that can react with calcium hydroxide to form cementitious calcium silicate. For example, in certain instances, the silicate (e.g., amorphous silicate) has a DOR* of greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 80%, or greater than or equal to 90%. In some cases, the silicate (e.g., amorphous silicate) has a DOR* of less than or equal to 100%, less than or equal to 95%, less than or equal to 90%, less than or equal to 85%, less than or equal to 80%, less than or equal to 70%, less than or equal to 65%, less than or equal to 60%, or less than or equal to 50%. Combinations of these ranges are also possible (e.g., greater than or equal to 30% and less than or equal to 100%). DOR* may be measured as described in Weiss (Bharadwaj, K., Isgor, O. B. & Weiss, W. J. A Simplified Approach to Determine Pozzolanic Reactivity of Commercial Supplementary Cementitious Materials. Towards the Development of Performance-Based Concrete Mixtures Made with Modern Cementitious Materials Using Thermodynamic Modeling 20 (2022)).

In certain embodiments, the silicate has Degree of Reactivity (DOR*) that is higher than the Degree of Reactivity (DOR*) of the material comprising silicate (e.g., crystalline silicate). For example, in some cases, the silicate has a Degree of Reactivity (DOR*) that is at least 10%, at least 20%, at least 30%, at least 40%, or at least 50% higher and/or less than or equal to 100%, less than or equal to 90%, less than or equal to 80%, less than or equal to 70%, or less than or equal to 60% higher (e.g., at least 10% and less than or equal to 100% higher) than the Degree of Reactivity (DOR*) of the material comprising silicate (e.g., crystalline silicate). For example, if the material comprising silicate (e.g., crystalline silicate) had a Degree of Reactivity (DOR*) of 10% and the silicate (e.g., amorphous silicate) had a Degree of Reactivity (DOR*) of 50%, the silicate would have a Degree of Reactivity (DOR*) that is 40% higher than tha Degree of Reactivity (DOR*) of the material comprising silicate.

In accordance with some embodiments, the silicate (e.g., amorphous silicate) comprises any combination of properties disclosed herein. For example, in certain cases, the silicate (e.g., amorphous silicate) comprises fluoride (e.g., any amount disclosed herein) (e.g., greater than or equal to 10 ppm and less than or equal to 20 wt. % fluoride or greater than or equal to 10 ppm and less than or equal to 250 ppm fluoride) and a tap density disclosed herein (e.g., greater than or equal to 0.1 g/cm³ and less than or equal to 2.0 g/cm³, greater than or equal to 0.2 g/cm³ and less than or equal to 1.9 g/cm³, greater than or equal to 0.3 g/cm³ and less than or equal to 1.8 g/cm³, greater than or equal to 0.5 g/cm³ and less than or equal to 1.8 g/cm³, or greater than or equal to 1.0 g/cm³ and less than or equal to 1.8 g/cm³), and optionally a specific surface area disclosed herein (e.g., greater than or equal to 1 m²/g and less than or equal to 2000 m²/g, greater than or equal to 1 m²/g and less than or equal to 1000 m²/g, greater than or equal to 1 m²/g and less than or equal to 100 m²/g, greater than or equal to 2 m²/g and less than or equal to 50 m²/g, greater than or equal to 5 m²/g and less than or equal to 20 m²/g, greater than or equal to 35 m²/g and less than or equal to 100 m²/g, or greater than or equal to 40 m²/g and less than or equal to 100 m²/g) and/or comprises metals (e.g., greater than or equal to 1000 ppm and less than or equal to 10,000 ppm total metals).

In some instances, the silicate (e.g., amorphous silicate) is produced by any method disclosed herein. For example, in certain cases, the silicate (e.g., hexafluorosilicate) is produced by combining ammonium fluoride and/or ammonium bifluoride with a material comprising silicate. In accordance with some embodiments, the silicate (e.g., hexafluorosilicate) is produced by combining ammonium fluoride and/or ammonium bifluoride with a material comprising silicate in an aqueous combination at a maximum temperature of greater than or equal to 10° C. and less than or equal to 125° C. and a maximum pressure of greater than or equal to 0.1 atm and less than or equal to 100 atm or a maximum pressure of greater than or equal to 1 atm and less than or equal to 100 atm. According to certain embodiments, the silicate (e.g., hexafluorosilicate) is produced by combining ammonium fluoride and/or ammonium bifluoride with a material comprising silicate in an anhydrous combination at a maximum temperature of greater than or equal to 160° C. and less than or equal to 250° C. and a maximum pressure of greater than or equal to 0.1 atm and less than or equal to 100 atm or a maximum pressure of greater than or equal to 1 atm and less than or equal to 100 atm.

Certain aspects are related to cementitious materials. Examples of cementitious materials include building and construction materials, cement, mortar, concrete, supplemental cementitious additives, pozzolans, and/or pozzolanic cements. In certain embodiments, a pozzolan comprises a siliceous or siliceous and aluminous material which, in itself, possesses little or no cementitious value but which will, in finely divided form in the presence of moisture, react chemically with a source of calcium (e.g., calcium hydroxide) at ordinary temperature to form compounds possessing cementitious properties.

In some embodiments, the cementitious material (e.g., cement) comprises any amorphous silicate disclosed herein. In some embodiments, the silicate (e.g., amorphous silicate) is suitable for use in cementitious materials.

In certain embodiments, the cementitious material (e.g., cement) has a suitable water demand (e.g., mass ratio of water required to bring a water-cement mixture to a normal consistency as determined by a Vicat Needle penetration test (ASTM C191-21) and/or a “normal flow” as defined by a Flow Table test (ASTM C230)). For example, in some cases, the cementitious material (e.g., cement) has a water demand of less than or equal to 0.6, less than or equal to 0.55, less than or equal to 0.5, or less than or equal to 0.4. In certain instances, the cementitious material (e.g., cement) has a water demand of greater than 0, greater than or equal to 0.1, greater than or equal to 0.2, or greater than or equal to 0.3. Combinations of these ranges are also possible (e.g., greater than 0 and less than or equal to 0.6, greater than or equal to 0.1 and less than or equal to 0.6, or greater than or equal to 0.3 and less than or equal to 0.5).

According to some embodiments, the cementitious material meets or exceeds the chemical and/or physical standards (e.g., composition, fineness, autoclave length change, time of setting (Vicat test), air content of mortar volume, compressive strength (1, 3, 7, 28 days), heat of hydration, mortar bar expansion, and/or sulfate expansion) of ASTM C1157 (2010).

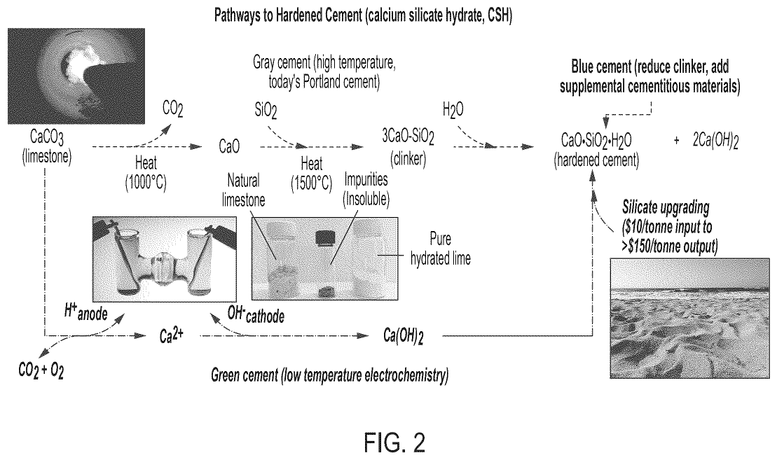

In some instances, the cementitious materials (e.g., concrete) is produced by any method disclosed herein. FIG. 2 shows some possible methods to produce cement (e.g., hardened cement) (e.g., calcium silicate hydrate, CSH)), in accordance with some embodiments.

Certain aspects relate to methods. In some embodiments, the method is a method of producing a silicate (e.g., amorphous silicate) and/or a salt (e.g., a lithium salt, such as lithium fluoride, lithium carbonate, lithium hydroxide, and/or lithium chloride, and/or an aluminum salt, such as aluminum fluoride, ammonium hexafluoroaluminate, lithium hexafluoroaluminate (lithium cryolite) and/or sodium hexafluoroaluminate (sodium cryolite) and/or potassium hexafluoroaluminate (potassium cryolite)).

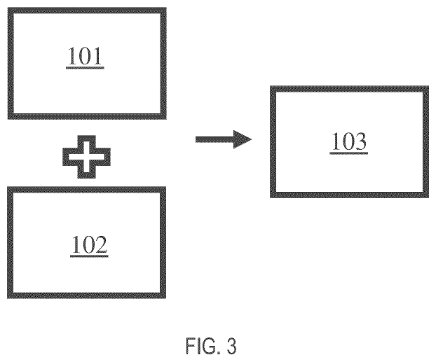

In some embodiments, the method comprises combining ammonium fluoride and/or ammonium bifluoride with a material comprising silicate. For example, in FIG. 3, the method comprises combining ammonium fluoride and/or ammonium bifluoride 101 with material comprising silicate 102.

In certain embodiments, the method comprises combining ammonium fluoride and/or ammonium bifluoride with a material comprising silicate in an aqueous combination and/or in an anhydrous combination (e.g., an ammonium fluoride and/or ammonium bifluoride melt). In some instances, combining ammonium fluoride and/or ammonium bifluoride with a material comprising silicate in an aqueous combination provides one or more benefits, such as less decomposition of the ammonium fluoride and/or ammonium bifluoride (e.g., compared to an anhydrous combination), less ammonium hexafluorosilicate leaching (e.g., compared to an anhydrous combination), lower energy use (e.g., compared to an anhydrous combination), higher ease of operating as a continuous process (e.g., compared to an anhydrous combination), and/or higher ease of operating at large-scale (e.g., compared to an anhydrous combination).

The method and/or a step thereof (e.g., the step of combining ammonium fluoride and/or ammonium bifluoride with a material comprising silicate in an aqueous combination) may be at a suitable maximum temperature. For example, in some cases, the maximum temperature is greater than or equal to 10° C., greater than or equal to 20° C., greater than or equal to 30° C., greater than or equal to 40° C., greater than or equal to 50° C., greater than or equal to 60° C., greater than or equal to 70° C., greater than or equal to 80° C., or greater than or equal to 90° C. In some embodiments, the maximum temperature is greater than the freezing point of the aqueous combination. In certain instances, the maximum temperature is less than or equal to 125° C., less than or equal to 120° C., less than or equal to 115° C., less than or equal to 110° C., less than or equal to 105° C., less than or equal to 100° C., less than or equal to 95° C., or less than or equal to 90° C. In certain embodiments, the maximum temperature is less than the boiling point of the aqueous combination. Combinations of these ranges are also possible (e.g., greater than or equal to 10° C. and less than or equal to 125° C., greater than or equal to 20° C. and less than or equal to 100° C., greater than or equal to 50° C. and less than or equal to 125° C., greater than or equal to 50° C. and less than or equal to 100° C., or greater than the freezing point and less than the boiling point of the aqueous combination). In accordance with some embodiments, the maximum temperature is the maximum temperature of the material comprising silicate when the material comprising silicate contacts the ammonium fluoride and/or the ammonium bifluoride.

The method and/or a step thereof (e.g., the step of combining ammonium fluoride and/or ammonium bifluoride with a material comprising silicate in an aqueous combination) may be at a suitable maximum pressure. For example, in some instances, the maximum pressure is greater than or equal to 0.1 atm, greater than or equal to 0.5 atm, greater than or equal to 1 atm, greater than or equal to 2 atm, greater than or equal to 3 atm, greater than or equal to 5 atm, greater than or equal to 10 atm, greater than or equal to 20 atm, greater than or equal to 30 atm, or greater than or equal to 40 atm. In certain cases, the maximum pressure is less than or equal to 100 atm, less than or equal to 90 atm, less than or equal to 80 atm, less than or equal to 70 atm, less than or equal to 60 atm, less than or equal to 50 atm, less than or equal to 40 atm, less than or equal to 30 atm, less than or equal to 20 atm, less than or equal to 10 atm, less than or equal to 5 atm, less than or equal to 3 atm, or less than or equal to 2 atm. Combinations of these ranges are also possible (e.g., greater than or equal to 0.1 atm and less than or equal to 100 atm, greater than or equal to 1 atm and less than or equal to 100 atm, or greater than or equal to 1 atm and less than or equal to 2 atm). In some embodiments, the maximum pressure is 1 atm. In accordance with some embodiments, the maximum pressure is the maximum pressure of the environment in which the material comprising silicate is contained when the material comprising silicate contacts the ammonium fluoride and/or the ammonium bifluoride.

Combinations of these maximum temperature ranges and these maximum pressure ranges are also possible. For example, according to certain embodiments, the method and/or a step thereof (e.g., the step of combining ammonium fluoride and/or ammonium bifluoride with a material comprising silicate in an aqueous combination) is at a maximum temperature of greater than or equal to 10° C. and less than or equal to 125° C. and a maximum pressure of greater than or equal to 0.1 atm and less than or equal to 100 atm or a maximum pressure of greater than or equal to 1 atm and less than or equal to 100 atm. As another example, according to some embodiments, the method and/or a step thereof (e.g., the step of combining ammonium fluoride and/or ammonium bifluoride with a material comprising silicate in an aqueous combination) is at a maximum temperature of greater than or equal to 10° C. and less than or equal to 125° C. and a maximum pressure of greater than or equal to 0.1 atm and less than or equal to 100 atm or a maximum pressure of greater than or equal to 1 atm and less than or equal to 2 atm.

The method and/or a step thereof (e.g., the step of combining ammonium fluoride and/or ammonium bifluoride with a material comprising silicate in an anhydrous combination) may be at a suitable maximum temperature. For example, in some cases, the maximum temperature is greater than or equal to 160° C., greater than or equal to 170° C., greater than or equal to 180° C., greater than or equal to 190° C., greater than or equal to 200° C., or greater than or equal to 210° C. According to certain embodiments, the maximum temperature is less than or equal to 250° C., less than or equal to 240° C., less than or equal to 230° C., less than or equal to 220° C., less than or equal to 210° C., less than or equal to 200° C., or less than or equal to 190° C. Combinations of these ranges are also possible (e.g., greater than or equal to 160° C. and less than or equal to 250° C.). In accordance with some embodiments, the maximum temperature is the maximum temperature of the material comprising silicate when the material comprising silicate contacts the ammonium fluoride and/or the ammonium bifluoride.

The method and/or a step thereof (e.g., the step of combining ammonium fluoride and/or ammonium bifluoride with a material comprising silicate in an anhydrous combination) may be at a suitable maximum pressure. For example, in some instances, the maximum pressure is greater than or equal to 0.1 atm, greater than or equal to 0.5 atm, greater than or equal to 1 atm, greater than or equal to 2 atm, greater than or equal to 3 atm, greater than or equal to 5 atm, greater than or equal to 10 atm, greater than or equal to 20 atm, greater than or equal to 30 atm, or greater than or equal to 40 atm. In certain cases, the maximum pressure is less than or equal to 100 atm, less than or equal to 90 atm, less than or equal to 80 atm, less than or equal to 70 atm, less than or equal to 60 atm, less than or equal to 50 atm, less than or equal to 40 atm, less than or equal to 30 atm, less than or equal to 20 atm, less than or equal to 10 atm, less than or equal to 5 atm, less than or equal to 3 atm, or less than or equal to 2 atm. Combinations of these ranges are also possible (e.g., greater than or equal to 0.1 atm and less than or equal to 100 atm, greater than or equal to 1 atm and less than or equal to 100 atm, or greater than or equal to 1 atm and less than or equal to 2 atm). In some embodiments, the maximum pressure is 1 atm. In accordance with some embodiments, the maximum pressure is the maximum pressure of the material comprising silicate when the material comprising silicate contacts the ammonium fluoride and/or the ammonium bifluoride.

Combinations of these maximum temperature ranges and these maximum pressure ranges are also possible. For example, according to certain embodiments, the method and/or a step thereof (e.g., the step of combining ammonium fluoride and/or ammonium bifluoride with a material comprising silicate in an anhydrous combination) is at a maximum temperature of greater than or equal to 160° C. and less than or equal to 250° C. and a maximum pressure of greater than or equal to 0.1 atm and less than or equal to 100 atm or a maximum pressure of greater than or equal to 1 atm and less than or equal to 100 atm. As another example, in accordance with some embodiments, the method and/or a step thereof (e.g., the step of combining ammonium fluoride and/or ammonium bifluoride with a material comprising silicate in an anhydrous combination) is at a maximum temperature of greater than or equal to 160° C. and less than or equal to 250° C. and a maximum pressure of greater than or equal to 0.1 atm and less than or equal to 2 atm or a maximum pressure of greater than or equal to 1 atm and less than or equal to 2 atm.

In some instances, the method comprises only partially reacting and/or partially dissolving the material comprising silicate with the ammonium fluoride and/or ammonium bifluoride. For example, in certain cases, greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, or greater than or equal to 95 wt. % of the material comprising silicate is reacted and/or dissolved with the ammonium fluoride and/or ammonium bifluoride. In some embodiments, less than 100 wt. %, less than or equal to 99 wt. %, less than or equal to 95 wt. %, less than or equal to 90 wt. %, less than or equal to 80 wt. %, less than or equal to 70 wt. %, less than or equal to 60 wt. %, or less than or equal to 50 wt. % of the material comprising silicate is reacted and/or dissolved with the ammonium fluoride and/or ammonium bifluoride. Combinations of these ranges are also possible (e.g., greater than or equal to 10 wt. % and less than 100 wt. % or greater than or equal to 10 wt. % and less than or equal to 99 wt. %). In certain embodiments, the method comprises fully reacting and/or dissolving the material comprising silicate with the ammonium fluoride and/or ammonium bifluoride.

In certain embodiments, the method produces and/or accumulates little to no hydrogen fluoride (HF). For example, in some instances, the method produces and/or accumulates little to no hydrogen fluoride (HF) gas.

In some cases, the method produces and/or accumulates less than or equal to 30 ppm, less than or equal to 25 ppm, less than or equal to 20 ppm, less than or equal to 15 ppm, less than or equal to 10 ppm, less than or equal to 5 ppm, less than or equal to 3 ppm, or less than or equal to 1 ppm HF (e.g., HF gas) (e.g., within 30 minutes of combining ammonium fluoride and/or ammonium bifluoride with a material comprising silicate).

In some embodiments, the method does not produce and/or accumulate a substantial net amount of hydrogen fluoride (HF). For example, in certain cases, the method does not produce and/or accumulate a substantial net amount of hydrogen fluoride (HF) gas.

In certain cases, the combination of the material comprising silicate and the ammonium fluoride and/or ammonium bifluoride (e.g., the aqueous combination and/or the anhydrous combination) has substantially no detectable quantities of free HF (e.g., free HF gas) by fluorine nuclear magnetic resonance (¹⁹F NMR) spectroscopy (e.g., no ¹⁹F signal of free HF occurring with a signal-to-noise (SNR) ratio of 3.0) and/or has substantially no observable quantities of HF (e.g., gas) within the vicinity (e.g., within 0.1 meters) of the process by moistened fluoride ion detection paper with a sensitivity limit of 20 mg/L (e.g., no yellow coloration indicating the presence of fluoride of the fluoride ion detection paper that is macroscopically observable) and/or has substantially no observable quantities of HF (e.g., gas) within the vicinity (e.g., within 0.1 meters) of the process by a NIST-rated HF gas detector with a sensitivity of +/−0.1 ppm.

According to some embodiments, the method comprises regenerating the ammonium fluoride and/or ammonium bifluoride. For example, in certain cases, the method comprises regenerating greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, or greater than or equal to 90 wt. % of the ammonium fluoride and/or ammonium bifluoride. In some instances, the method comprises regenerating less than or equal to 100 wt. %, less than or equal to 99 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, or less than or equal to 30 wt. % of the ammonium fluoride and/or ammonium bifluoride. Combinations of these ranges are also possible (e.g., greater than or equal to 10 wt. % and less than or equal to 100 wt. %).

In certain cases, the material comprising silicate comprises a crystalline silicate. In some instances, the material comprising silicate further comprises an additional element (e.g., lithium or aluminum) or two or more additional elements (e.g., lithium and aluminum). According to some embodiments, the material comprising silicate comprises allanite and/or allanite-type materials, olivine and/or olivine-type materials, montmorillonite and/or montmorillonite-type materials, kaolinite and/or kaolinite-type materials, halloysite and/or halloysite-type materials, kyanite and/or kyanite-type materials, sillimanite and/or sillimanite-type materials, spodumene and/or spodumene-type materials, petalite and/or petalite-type materials, eucryptite and/or eucryptite-type materials, quartz and/or quartz-type materials, mullite and/or mullite-type materials, zircon and/or zircon-type materials, wollastonite and/or wollastonite-type materials, basalt and/or basalt-type materials, lepidolite and/or lepidolite-type materials, amblygonite and/or amblygonite-type materials, triphylite and/or triphylite-type materials, bikitaite and/or bikitaite-type materials, lithiophilite and/or lithiophilite-type materials, illite and/or illite-type materials, smectite and/or smectite-type materials, jadarite and/or jadarite-type materials, cookeite and/or cookeite-type materials, montebrasite and/or montebrasite-type materials, elbaite and/or elbaite-type materials, zinnwaldite and/or zinnwaldite-type materials, rare earth element (REE) sands, laterite clays, desert sand, ash resulting from fossil fuel combustion (such as bottom ash, ponded ash, fly ash), and/or residue resulting from industrial processes (such as mining tailings and/or bauxite residue). For example, according to certain embodiments, the material comprising silicate (e.g., the material comprising silicate and lithium and/or aluminum) comprises allanite, olivine, montmorillonite, kaolinite, halloysite, kyanite, sillimanite, spodumene, petalite, eucryptite, quartz, mullite, zircon, wollastonite, basalt, lepidolite, amblygonite, triphylite, bikitaite, lithiophilite, illite, smectite, jadarite, cookeite, montebrasite, elbaite, zinnwaldite, rare earth element (REE) sands, laterite clays, desert sand, ash resulting from fossil fuel combustion (such as bottom ash, ponded ash, fly ash), and/or residue resulting from industrial processes (such as mining tailings and/or bauxite residue).

In some instances, the material comprising silicate (e.g., crystalline silicate) has a DOR* of greater than or equal to 0%, greater than or equal to 5%, greater than or equal to 10%, greater than or equal to 15%, or greater than or equal to 20%. In some cases, the material comprising silicate (e.g., crystalline silicate) has a DOR* of less than 30%, less than or equal to 25%, less than or equal to 20%, less than or equal to 15%, less than or equal to 10%, less than or equal to 5%, less than or equal to 3%, less than or equal to 1%, or 0%. Combinations of these ranges are also possible (e.g., greater than or equal to 0% and less than 30% or greater than or equal to 0% and less than or equal to 25%).

In certain embodiments, the method comprises producing a silicate (e.g., an amorphous silicate) and/or a salt (e.g., a lithium salt—such as lithium fluoride, lithium carbonate, lithium hydroxide, and/or lithium chloride—and/or an aluminum salt—such as aluminum fluoride, ammonium hexafluoroaluminate, lithium hexafluoroaluminate (lithium cryolite) and/or sodium hexafluoroaluminate (sodium cryolite) and/or potassium hexafluoroaluminate (potassium cryolite)). For example, in FIG. 3, the method comprises producing product 103. In some cases, product 103 comprises a silicate (e.g., an amorphous silicate). In certain instances, product 103 comprises a salt (e.g., a lithium salt—such as lithium fluoride, lithium carbonate, lithium hydroxide, and/or lithium chloride—and/or an aluminum salt—such as aluminum fluoride, ammonium hexafluoroaluminate, lithium hexafluoroaluminate (lithium cryolite), and/or sodium hexafluoroaluminate (sodium cryolite)). In some embodiments, product 103 comprises a silicate (e.g., an amorphous silicate) and a salt (e.g., a lithium salt—such as lithium fluoride, lithium carbonate, lithium hydroxide, and/or lithium chloride—and/or an aluminum salt—such as aluminum fluoride, ammonium hexafluoroaluminate, lithium hexafluoroaluminate (lithium cryolite), and/or sodium hexafluoroaluminate (sodium cryolite)).

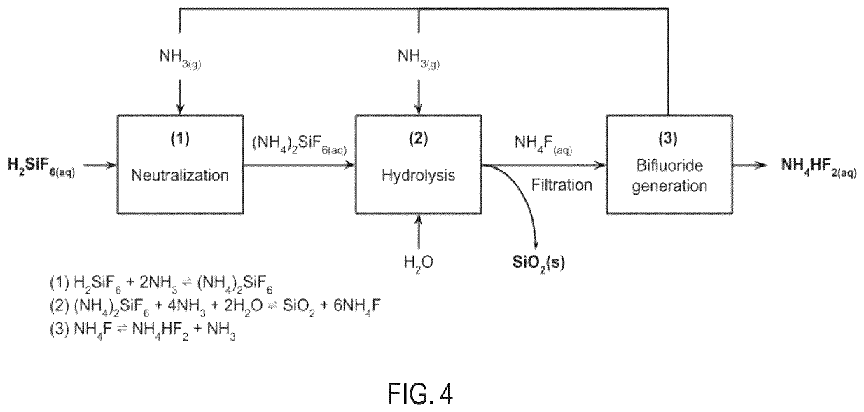

Some examples of methods are shown in FIGS. 4, 5A, 5B, 6A, 6B, 6C, 7, and 8.

For example, FIG. 4 shows a method comprising neutralization of acidic fluorosilicates generating ammonium fluorosilicate species (1), further addition of base hydrolyzes the ammonium fluorosilicates in the presence of water (2), and heating of the resultant solution after filtration generates ammonium bifluoride and equivalents of ammonia (3) that can be introduced into prior steps, in accordance with some embodiments. In the first step in FIG. 4, in some cases, H₂SiF_{6(aq)} is combined with NH_{3(g)} to produce (NH₄)₂SiF_{6(aq)}. In the second step in FIG. 4, in certain instances, (NH₄)₂SiF_{6(aq)} is combined with H₂O and NH_{3(g)} to produce SiO₂₍ₛ₎ and NH₄F_{(aq)}. In the third step in FIG. 4, in certain cases, NH₄HF_{2(aq)} and NH_{3(g)} are produced from NH₄F_{(aq)}. In FIG. 4, in some embodiments, the NH_{3(g)} produced is used to repeat the first step.

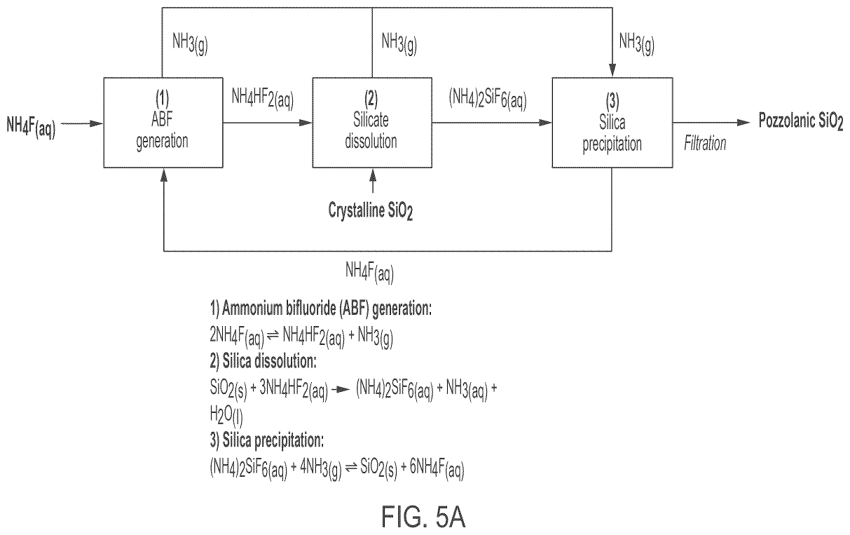

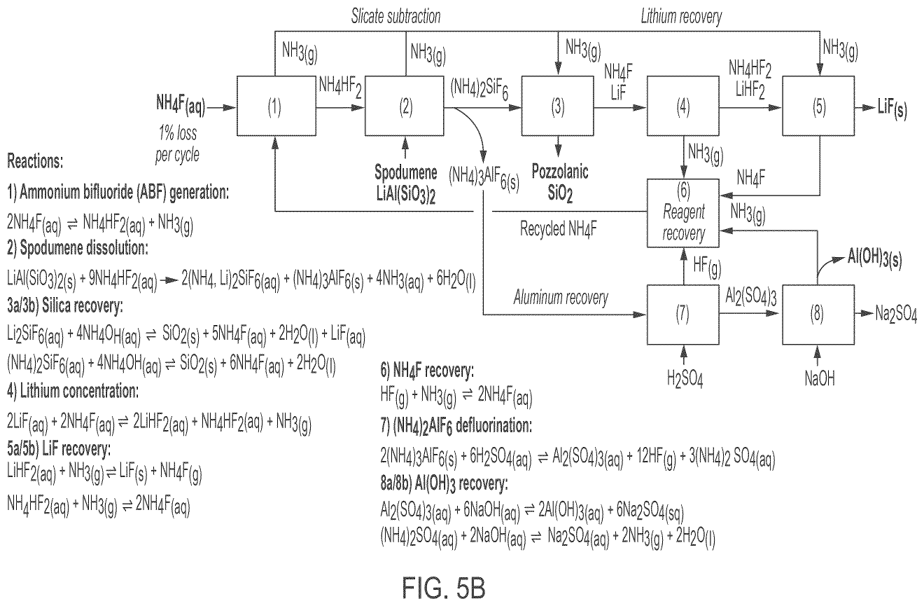

As another example, FIG. 5A shows a three-step process that generates amorphous SiO₂ from crystalline silica, in accordance with some embodiments. In the first step in FIG. 5A, in some cases, ammonium bifluoride and ammonia are generated from ammonium fluoride. In the second step in FIG. 5A, in certain instances, a silicate (e.g., crystalline silica) is combined with ammonium bifluoride to produce ammonium hexafluorosilicate, ammonia, and water. In the third step in FIG. 5A, in accordance with some embodiments, the ammonium hexafluorosilicate is combined with ammonia to precipitate an amorphous silicate and ammonium fluoride.

As another example, FIG. 5B shows a process of processing a lithium aluminosilicate, such as spodumene, to produce pozzolanic SiO₂ and/or a lithium salt and/or an aluminum salt, in accordance with some embodiments. For example, in FIG. 5B, in step 1, in some cases, ammonium bifluoride and ammonia are generated from ammonium fluoride. In step 2 of FIG. 5B, in certain instances, spodumene is combined with ammonium bifluoride to produce Li₂SiF₆ and/or (NH₄)₂SiF₆, and water, ammonia, and (NH₄)₃AlF₆. In step 3 of FIG. 5B, according to some embodiments, the Li₂SiF₆ and/or (NH₄)₂SiF₆ produced in step 2 is combined with NH₄OH to produce amorphous silica, NH₄F, water, and/or LiF. In step 4 of FIG. 5B, according to certain embodiments, LiF is combined with ammonium fluoride to generate LiHF₂, ammonium bifluoride, and ammonia. In step 5 of FIG. 5B, in accordance with some embodiments, ammonia is combined with LiHF₂ and/or ammonium bifluoride to generate ammonium fluoride and/or LiF. In step 6 of FIG. 5B, in accordance with certain embodiments, HF and ammonia are combined to form ammonium fluoride. In step 7 of FIG. 5B, in some cases, (NH₄)₃AlF₆ is combined with sulfuric acid to produce Al₂(SO₄)₃, HF, and (NH₄)₂SO₄. In step 8 of FIG. 5B, in certain instances, NaOH is combined with Al₂(SO₄)₃ and/or (NH₄)₂SO₄ to produce Al(OH)₃, NH₃, water, and/or Na₂SO₄.

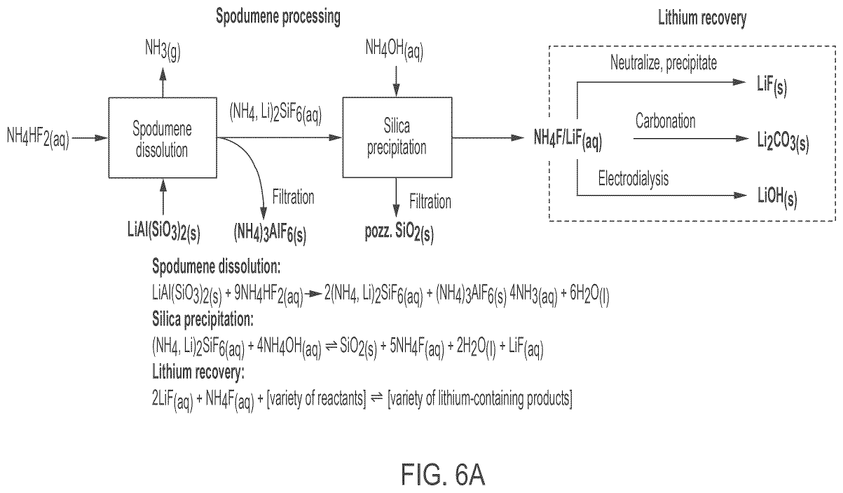

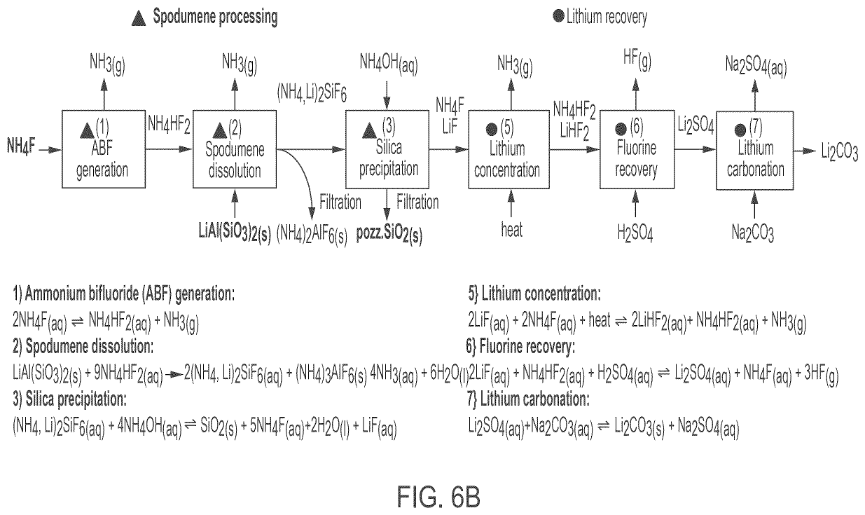

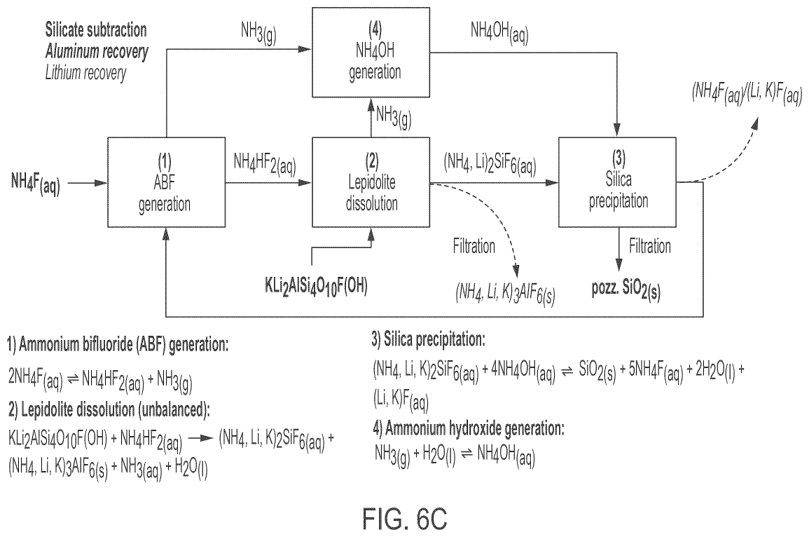

In yet another example, FIG. 6A shows a process of producing various Li salts and/or pozzolanic silica from spodumene, in accordance with some embodiments. For example, in some instances, step 1 of FIG. 6A is combining spodumene and ammonium bifluoride to produce Li₂SiF₆ and/or (NH₄)₂SiF₆, and water, ammonia, and (NH₄)₃AlF₆.

In step 2 of FIG. 6A, in certain cases, NH₄OH is combined with the Li₂SiF₆ and/or (NH₄)₂SiF₆ to produce amorphous silica, water, ammonium fluoride, and LiF_{(aq)}. In step 3 of FIG. 6A, according to various embodiments, LiF₍ₛ₎, Li₂CO₃₍ₛ₎, and/or LiOH₍ₛ₎ may be produced from the LiF_{(aq)}, ammonium fluoride, and, optionally, other various reagents.

In yet another example, FIG. 6B shows a process of isolating lithium as Li₂CO₃ by carbonating a Li-rich solution after recovering the fluorine in a process of processing spodumene, in accordance with some embodiments. For example, in step 1 of FIG. 6B, in some embodiments, ammonium bifluoride and ammonia are generated from ammonium fluoride. In step 2 of FIG. 6B, in certain cases, ammonium bifluoride is combined with spodumene to produce Li₂SiF₆ and/or (NH₄)₂SiF₆, and water, ammonia, and (NH₄)₃AlF₆. In step 3 of FIG. 6B, in some instances, NH₄OH is combined with Li₂SiF₆ and/or (NH₄)₂SiF₆ to produce amorphous silica, ammonium fluoride, water, and LiF_{(aq)}. In step 5 of FIG. 6B, according to some embodiments, ammonium fluoride and LiF_{(aq)} are combined with heat to produce LiHF₂, ammonium bifluoride, and ammonia.

In step 6 of FIG. 6B, in accordance with certain embodiments, ammonium bifluoride, sulfuric acid, and LiF_{(aq)} are combined to produce Li₂SO₄, HF, and ammonium fluoride. In step 7 of FIG. 6B, in certain cases, Li₂SO₄ and Na₂CO₃ are combined to produce Li₂CO₃ and Na₂SO₄.

In yet another example, FIG. 6C shows a process for processing lepidolite to produce pozzolanic SiO₂, in accordance with some embodiments. In step 1 of FIG. 6C, in some embodiments, ammonium bifluoride and ammonia are produced from ammonium fluoride. In step 2 of FIG. 6C, in certain embodiments, ammonium bifluoride is combined with lepidolite to produce (NH₄, Li, K)₂SiF₆, (NH₄, Li, K)₃AlF₆, ammonia, and water. In step 3 of FIG. 6C, in some instances, (NH₄, Li, K)₂SiF₆ is combined with NH₄OH to produce amorphous silica, ammonium fluoride, water, and (Li, K)F. In step 4 of FIG. 6C, according to some embodiments, ammonia and water are combined to produce NH₄OH.

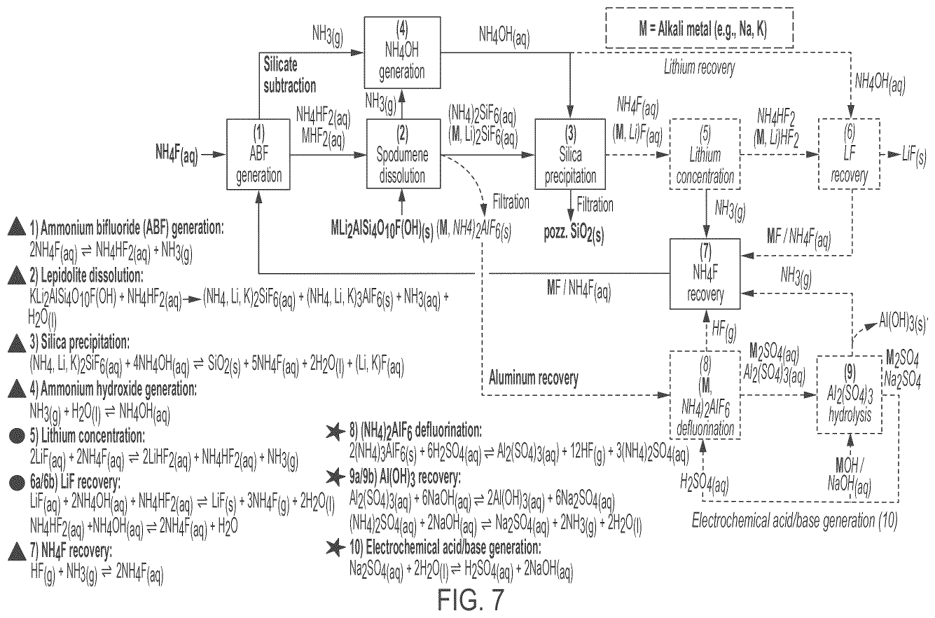

In yet another example, FIG. 7 shows a process of silicate subtraction that optionally includes a process for lithium recovery and/or a process of aluminum recovery, in accordance with some embodiments. In step 1 of FIG. 7, in some cases, ammonium bifluoride and ammonia are generated from ammonium fluoride. In step 2 of FIG. 7, in certain instances, ammonium bifluoride is combined with lepidolite to produce (NH₄, Li, K)₂SiF₆, (NH₄, Li, K)₃AlF₆, ammonia, and water. In step 3 of FIG. 7, in accordance with some embodiments, (NH₄, Li, K)₂SiF₆ is combined with NH₄OH to produce amorphous silica, ammonium fluoride, water, and (Li, K)F. In step 4 of FIG. 7, according to certain embodiments, ammonia and water are combined to produce NH₄₀H. In step 5 of FIG. 7, according to some embodiments, ammonium fluoride is combined with LiF_{(aq)} to produce ammonia, ammonium bifluoride, and LiHF₂. In step 6 of FIG. 7, in certain embodiments, ammonium hydroxide is combined with LiF and/or NH₄HF₂ to produce LiF, ammonium fluoride, and/or water. In step 7 of FIG. 7, in some cases, HF is combined with ammonia to produce ammonium fluoride. In step 8 of FIG. 7, in certain embodiments, (NH₄)₃AlF₆ is combined with sulfuric acid to produce Al₂(SO₄)₃, HF, and (NH₄)₂SO₄. In step 9 of FIG. 7, in certain cases, NaOH is combined with Al₂(SO₄)₃ and/or (NH₄)₂SO₄ to produce Al(OH)₃, Na₂SO₄, ammonia, and/or water.

In step 10 of FIG. 7, in some embodiments, Na₂SO₄ is combined with water to produce sulfuric acid and NaOH.

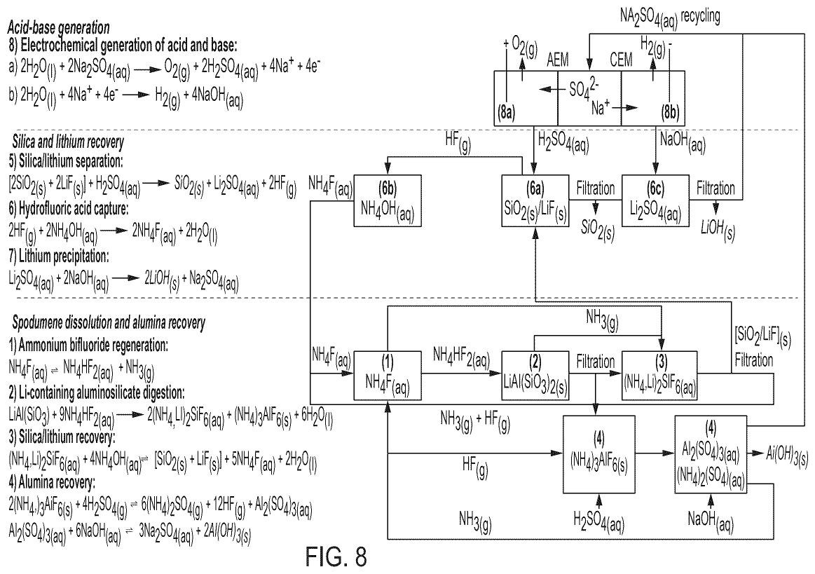

As another example, FIG. 8 shows a process for producing a silicate and/or salt, in accordance with some embodiments. In step 1 of FIG. 8, in some cases, ammonium bifluoride and ammonia are generated from ammonium fluoride. In step 2 of FIG. 8, in certain instances, ammonium bifluoride is combined with a lithium-containing aluminosilicate such as LiAl(SiO₃) to produce, for example, (NH₄, Li)₂SiF₆, (NH₄)₃AlF₆, and water. In step 3 of FIG. 8, in accordance with certain embodiments, NH₄OH is combined with (NH₄, Li)₂SiF₆ to produce silica, LiF, ammonium fluoride, and water. In step 4 of FIG. 8, according to some embodiments, (NH₄)₃AlF₆ is combined with sulfuric acid to produce (NH₄)₂SO₄, HF, and Al₂(SO₄)₃. Further, in step 4 of FIG. 8, according to certain embodiments, Al₂(SO₄)₃ is combined with NaOH to produce Na₂SO₄ and Al(OH)₃. In step 5 of FIG. 8, in some instances, silica, LiF, and sulfuric acid are combined to produce silica, Li₂SO₄, HF, and ammonium fluoride. In step 6 of FIG. 8, in certain cases, NH₄OH and HF are combined to produce ammonium fluoride and water.

In step 7 of FIG. 8, in some embodiments, Li₂SO₄ is combined with NaOH to produce LiOH and Na₂SO₄. In step 8 of FIG. 8, in certain embodiments, acid and/or base are generated electrochemically.

It should be understood that some of the steps shown in FIGS. 4, 5A, 5B, 6A, 6B, 6C, 7, and 8 are optional, in some embodiments. It should be understood that the steps in FIGS. 4, 5A, 5B, 6A, 6B, 6C, 7, and 8 may be performed in a non-sequential order, in certain cases. It should be understood that, in accordance with various embodiments, the compounds discussed above may be in solid, liquid, aqueous, and/or gas state.

In some embodiments, the method comprises producing a silicate (e.g., an amorphous silicate), such as any silicate (e.g., amorphous silicate) disclosed herein. In some cases, the silicate (e.g., amorphous silicate) comprises a lower weight percentage of lithium than the material comprising silicate. For example, in certain instances, the silicate (e.g., amorphous silicate) comprises greater than or equal to 1 wt. %, greater than or equal to 3 wt. %, greater than or equal to 5 wt. %, greater than or equal to 10 wt. %, greater than or equal to 15 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, or greater than or equal to 95 wt. % less lithium than the material comprising silicate. In certain embodiments, the silicate (e.g., amorphous silicate) comprises less than or equal to 100 wt. %, less than or equal to 99 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, less than or equal to 10 wt. %, or less than or equal to 5 wt. % less lithium than the material comprising silicate. Combinations of these ranges are also possible (e.g., greater than or equal to 1 wt. % and less than or equal to 100 wt. % or greater than or equal to 1 wt. % and less than or equal to 95 wt. % less lithium than the material comprising silicate). For example, if the material comprising silicate comprised 20 wt. % lithium and the silicate comprised 5 wt. % lithium, then the silicate would comprise 15 wt. % less lithium than the material comprising silicate.

In certain embodiments, the method comprises producing a salt. In some cases, the method comprises producing a salt in addition to the silicate (e.g., amorphous silicate). In certain instances, the method comprises producing a salt without producing the silicate. In some embodiments, the salt comprises lithium and/or aluminum. In some cases, the salt comprises lithium fluoride, lithium carbonate, lithium hydroxide, and/or lithium chloride. In certain cases, the salt comprises lithium fluoride. According to some embodiments, the method comprises producing a salt used in an electrolyte from the lithium fluoride, lithium carbonate, lithium hydroxide, and/or lithium chloride. In some embodiments, the electrolyte salt is LiPF₆. In some embodiments, the method comprises using the salt in a battery, such as a lithium battery (e.g., a lithium-ion battery). In accordance with certain embodiments, the method comprises using the LiPF₆ in a lithium battery, such as a lithium-ion battery. According to some embodiments, the method comprises producing a cathode comprising the lithium carbonate, and/or lithium chloride, and/or lithium hydroxide. In accordance with certain embodiments, the method comprises producing a lithium battery comprising the cathode. In some instances, the salt comprises aluminum fluoride, ammonium hexafluoroaluminate, lithium hexafluoroaluminate (lithium cryolite), and/or sodium hexafluoroaluminate (sodium cryolite) and/or potassium hexafluoroaluminate (potassium cryolite)).

In some instances, the salt (e.g., lithium salt, such as lithium fluoride, lithium carbonate, lithium hydroxide, and/or lithium chloride) comprises a higher weight percentage of lithium than the material comprising silicate. For example, in certain instances, the salt (e.g., lithium salt, such as lithium fluoride, lithium carbonate, lithium hydroxide, and/or lithium chloride) comprises greater than or equal to 1 wt. %, greater than or equal to 3 wt. %, greater than or equal to 5 wt. %, greater than or equal to 10 wt. %, greater than or equal to 15 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, or greater than or equal to 95 wt. % more lithium than the material comprising silicate. In certain embodiments, the (e.g., lithium salt, such as lithium fluoride, lithium carbonate, lithium hydroxide, and/or lithium chloride) comprises less than or equal to 100 wt. %, less than or equal to 99 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, less than or equal to 10 wt. %, or less than or equal to 5 wt. % more lithium than the material comprising silicate. Combinations of these ranges are also possible (e.g., greater than or equal to 1 wt. % and less than or equal to 100 wt. % or greater than or equal to 1 wt. % and less than or equal to 95 wt. % more lithium than the material comprising silicate). For example, if the material comprising silicate comprised 20 wt. % lithium and the salt comprised 50 wt. % lithium, then the salt would comprise 30 wt. % more lithium than the material comprising silicate.

In accordance with some embodiments, the method comprises forming an aluminum oxide and/or aluminum hydroxide. For example, in certain cases, the method comprises forming an aluminum oxide and/or aluminum hydroxide in addition to a silicate (e.g., amorphous silicate) and/or a salt (e.g., a lithium salt, such as lithium fluoride, lithium carbonate, lithium hydroxide, and/or lithium chloride, and/or an aluminum salt, such as aluminum fluoride, ammonium hexafluoroaluminate, lithium hexafluoroaluminate (lithium cryolite) and/or sodium hexafluoroaluminate (sodium cryolite)).

In some instances, the aluminum oxide and/or aluminum hydroxide has a low concentration of an impurity, such as fluorine. For example, in certain embodiments, the aluminum oxide and/or aluminum hydroxide has less than or equal to 1 wt. %, less than or equal to 0.1 wt. %, less than or equal to 0.01 wt. %, less than or equal to 0.001 wt. %, or less than or equal to 0.0001 wt. % of an impurity, such as fluorine. In some cases, the aluminum oxide and/or aluminum hydroxide has greater than or equal to 0 wt. % of an impurity, such as fluorine. Combinations of these ranges are also possible (e.g., greater than or equal to 0 wt. % and less than or equal to 1 wt. % or greater than or equal to 0 wt. % and less than or equal to 0.0001 wt. %). In certain cases, the aluminum oxide and/or aluminum hydroxide has 0 wt. % of an impurity, such as fluorine.

In some instances, the aluminum oxide and/or aluminum hydroxide has high purity. For example, in certain cases, the aluminum oxide and/or aluminum hydroxide has a purity of greater than or equal to 99 wt. %, greater than or equal to 99.9 wt. %, greater than or equal to 99.99 wt. %, greater than or equal to 99.999 wt. %, or greater than or equal to 99.9999 wt. %. In some embodiments, the aluminum oxide and/or aluminum hydroxide has a purity less than or equal to 100 wt. % (e.g., less than 100 wt. %). Combinations of these ranges are also possible (e.g., greater than or equal to 99 wt. % and less than or equal to 100 wt. % or greater than or equal to 99.9999 wt. % and less than or equal to 100 wt. % purity).

In some embodiments, the method comprises producing a separator comprising the aluminum oxide. In certain embodiments, the method comprises producing a battery (e.g., a lithium battery) comprising the separator comprising the aluminum oxide.

In certain embodiments, the method comprises producing a cementitious material (e.g., cement) comprising the produced amorphous silicate. In some embodiments, the method comprises producing a cementitious material (e.g., cement) comprising the aluminum oxide and/or aluminum hydroxide. According to some embodiments, the method comprises producing a cementitious material (e.g., cement) comprising the amorphous silicate and aluminum oxide and/or aluminum hydroxide. In certain cases, a ratio of aluminum to silicon is selected to achieve a desired composition of hardened cementitious material, such as a calcium aluminosilicate hydrate (CASH).

Certain embodiments are directed to collections of particles comprising silicate (e.g., any of the silicates described elsewhere herein). In some embodiments, within the collection of particles, at least 90 wt %, at least 95% wt %, at least 98 wt %, at least 99 wt %, at least 99.9 wt %, or at least 99.99 wt % of the total weight of the particles is made up of particles having a maximum cross-sectional dimension of greater than or equal to 0.01 microns, greater than or equal to 0.05 microns, greater than or equal to 0.1 microns, greater than or equal to 0.03 microns, greater than or equal to 0.05 microns, greater than or equal to 1 micron, greater than or equal to 2 microns, greater than or equal to 3 microns, greater than or equal to 5 microns, greater than or equal to 7 microns, or greater than or equal to 10 microns and/or less than or equal to 20 microns, less than or equal to 18 microns, less than or equal to 15 microns, less than or equal to 10 microns, less than or equal to 8 microns, less than or equal to 5 microns, less than or equal to 3 microns, or less than or equal to 2 microns. Such collections can be useful, for example, in cementitious materials.

The mineral spodumene, having the basic chemical formula LiAlSi₂O₆, is a major mineral source of lithium. Lepidolite, petalite, and eucryptite are related mineral sources for lithium that often co-exist in spodumene-bearing hard rock deposits. An additional mineral source of lithium is clays including smectite and illite. Extraction of lithium from such mineral deposits typically requires multiple steps including: i) grinding of the hard rock and/or clay; ii) floatation to isolate lithium-rich ores; iii) transformation of acid-resistant mineral phases (e.g., α-spodumene) to acid-leachable phases (e.g., 3-spodumene) via calcination; iv) sulfuric acid or sulfate roasting to extract the lithium as dissolved lithium sulfate; v) precipitation or carbonation of dissolved lithium to arrive at purified lithium salts such as LiOH or Li₂CO₃. Such processes are commercially practiced, but are expensive, energy-intensive, and produce undesirable waste.

In some embodiments, a source material comprising lithium and silica, including but not limited to lithium aluminum silicates such as spodumene (comprising a and/or p phases), lepidolite, petalite, eucryptite, and/or lithium silicate clays, including but not limited to smectite and illite, is valorized by silicate subtraction to produce at least: 1) a salt enriched in lithium, and 2) a silicate depleted in lithium compared to the starting material.

In one embodiment, said valorization by silicate subtraction is conducted by a method disclosed herein, wherein an ammonium fluoride compound is used to dissolve and then precipitate solid silica in a cyclic process that reuses said ammonium fluoride. In carrying out said cyclic process, in certain embodiments, the starting lithium-containing silicate is separated into at least a silica-rich fraction and a lithium-enriched fraction. In some embodiments, the lithium is isolated as a fluoride, which may be precipitated as a solid fluoride comprising lithium fluoride. Said solid lithium fluoride may be amorphous, disordered, nanocrystalline, or crystalline. Said lithium fluoride may comprise pure or impure lithium fluoride having a rocksalt structure type. In some embodiments, the lithium is isolated as lithium carbonate, lithium chloride, and/or lithium hydroxide.

Said lithium fluoride may be subsequently processed to produce LiPF₆, a key component for the production of lithium batteries, being widely used as a salt in the liquid electrolytes used in lithium batteries. For example, LiPF₆ may be made by the reaction of LiF with phosphorus pentafluoride, PF₅. Alternatively, said lithium fluoride may be processed to produce precursors to, or compounds, used in cathode-active or anode-active lithium storage electrodes for batteries, or lithium-conducting solid electrolytes used in batteries and other devices. Lithium salts used as input materials for the preparation of such compounds include lithium nitrate (LiNO₃), lithium carbonate (Li₂CO₃), and lithium hydroxide (LiOH). As a non-limiting example, LiF may be converted to LiNO₃ by reaction with nitric acid, HNO₃, producing HF as a co-product. Recovered fluorine may be re-used in the present process or in separate uses. Said LiNO₃ may be subsequently processed to yield LiOH or Li₂CO₃, both of which are used as precursors for the preparation of Li-ion battery cathodes. Examples of lithium metal oxides which may be produced are battery electrode compounds, including any of a broad range of cathode families including ordered and disordered rocksalt structure type oxides such as LiCoO₂, LiNiO₂, the nickel-manganese-cobalt “NMC” family of cathode oxides, and many other specific compositions. Said cathodes may include polyanion compounds such as the phospho-olivines, including by way of example LiFePO₄ and Li(Fe,Mn)PO₄, and spinels, including by way of example LiMn₂O₄ or Li(Mn,Ni)₂O₄. Anode-active compounds may include spinel oxides such as Li₄Ti₅O₁₂ (LTO). Lithium solid electrolytes may include compounds in the garnet or lithium superionic conductor (LiSICON) families, or chalcogenides such as the lithium-phosphorus-sulfides “LPS” and lithium-germanium-phosphorus-sulfides “LGPS”.

In some embodiments, aluminum in the starting mineral forms an ammonium aluminum fluoride, such as ammonium aluminum hexafluoride, (NH₄)₃AlF₆. In some embodiments this aluminum-bearing phase is separated from the silica-rich and/or lithium-rich fractions of the starting material. This aluminum-bearing phase may be subsequently decomposed to recover nitrogen, fluorine, and hydrogen atoms, which may be combined to form ammonium fluoride. In one particular embodiment, said ammonium aluminum hexafluoride is reacted with heated water and/or steam in order to valorize the aluminum as alumina and/or aluminum hydroxide. This reaction(s) may be described in one form as:

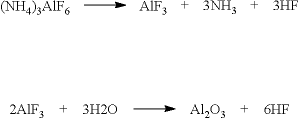

and may be conducted, as a non-limiting example, by reacting (NH₄)₃AlF₆₍ₛ₎ with superheated steam. At ambient pressure, the temperature for such reaction is preferably greater than about 500° C. and more preferably greater than about 650° C., in some cases, although other conditions for carrying out such reaction may be used. In some embodiments, cooling of the produced ammonia and hydrofluoric acid is performed in order to generate the ammonium fluoride according to the reaction:

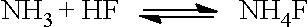

In some embodiments, the input mineral source is separated using said chemical loop silica subtraction process into at least two reaction product streams. In preferred embodiments, at least a silica-rich stream, a lithium-rich stream, and an aluminum-rich stream are produced from the input mineral source. In other embodiments, an additional product stream or streams rich in other elements may be simultaneously produced. For example, valorized products simultaneously or sequentially produced from the same input material may comprise a pure and reactive amorphous silica, a purified LiF salt, and purified alumina. Residue from the valorization of these three elements may itself be valorized due to the concentration of other elements, which may include main group metals, energy-relevant metals such as Cu, Co, or Ni, rare-earth elements (REEs), noble metals, and platinum-group metals (PGMs). In some embodiments, the silica product stream is used in the production of building and construction materials, including but not limited to cement, mortar, concrete, supplemental cementitious additives, pozzolans, or pozzolanic cements.

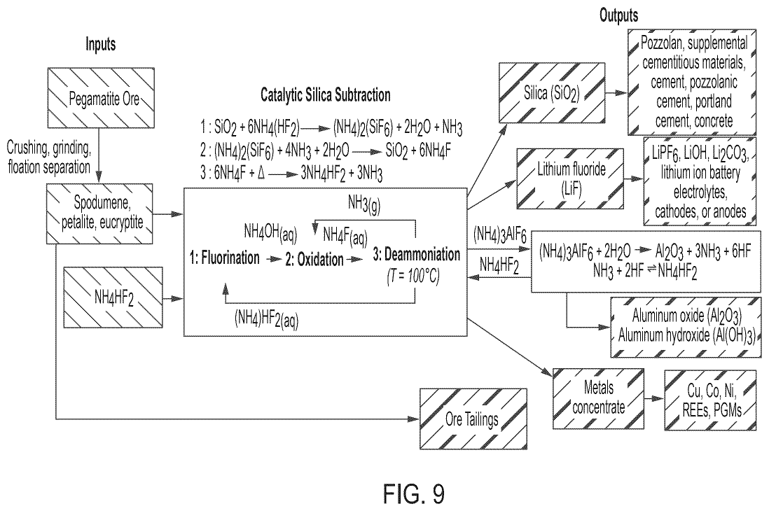

In some embodiments, the method comprises the above-described processes, the valorized materials produced as a result of conducting such processes, reactors designed to carry out such processes, and a system or subsystem combining at least two and preferably three or more unit operations carrying out the above described steps. Such a system is illustrated in FIG. 9.

The following examples are intended to illustrate certain embodiments of the present invention, but do not exemplify the full scope of the invention.

### Example 1

This example describes a process for generating ammonium fluoride (NH₄F). The process generated NH₄F and an amorphous silicate through reaction of an acidified fluorosilicate (e.g., H₂SiF₆) with an amine (e.g, NH₃). This example can be described by Reaction A.

### Ammonium Fluoride Generation (Reaction A)

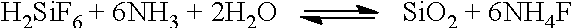

A solution of fluorosilicic acid (H₂SiF₆) was prepared by diluting 10.00 g of 35 wt. % of H₂SiF₆ in 250 ml of distilled H₂O in a PTFE round bottom flask. A solution of 10 wt. % ammonium hydroxide (NH₄OH) was added dropwise (250 mL total) with concomitant precipitation of a white solid. The solution was cooled in an ice bath, stirred for 1 hour, filtered and washed with cold water (~50 mL), and dried at 100° C. overnight (1.69 g yield). The SEM-EDS of the initial precipitate prior to filtration showed an amorphous solid composed of silicon and oxygen by EDS. The X-ray diffraction (XRD) analysis of this material indicated that the material was amorphous, with trace unhydrolyzed (NH₄)₂SiF₆. The filtrate was collected (4.62 g yield) and reduced to dryness at ambient temperature to yield a white, crystalline solid, which was NH₄F and NH₄HF₂ in a 9:1 ratio according to the XRD analysis.

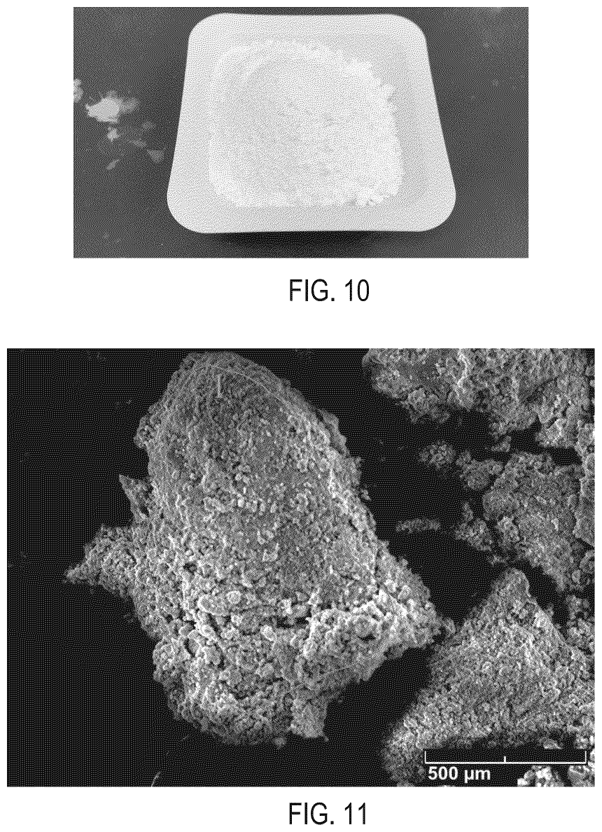

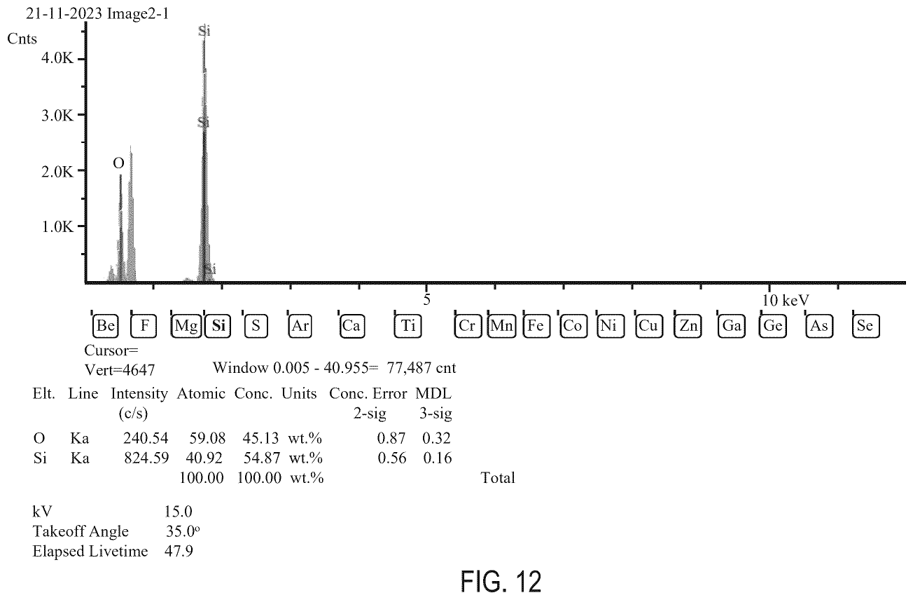

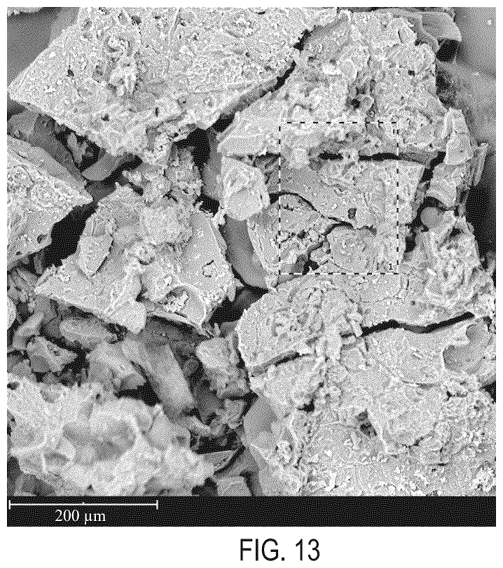

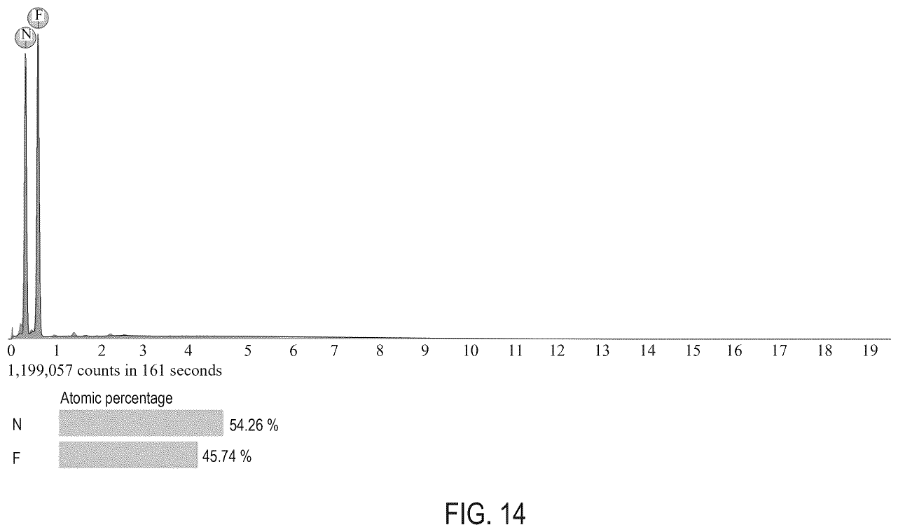

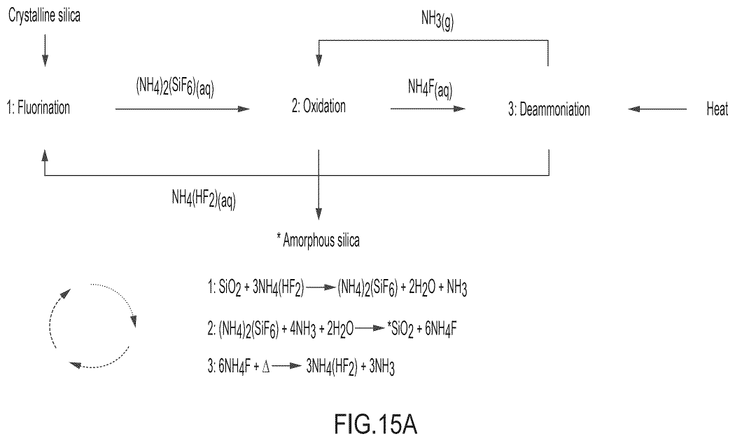

The amorphous SiO₂ generated is shown in FIG. 10. It was characterized by scanning electron microscopy (SEM) and electron dispersive spectroscopy (EDS) as shown in FIG. 11 and FIG. 12, respectively. The ammonium fluoride generated was characterized by scanning electron microscopy (SEM) and electron dispersive spectroscopy (EDS) as shown in FIG. 13 and FIG. 14, respectively.

### Example 2

This example describes a process for generating ammonium bifluoride (NH₄HF₂). The process described generates NH₄F through reaction of an acidified fluorosilicate (e.g., H₂SiF₆) with ammonia (NH₃) to generate an amorphous silicate and a solution of fluorine-containing ammonium salts. The soluble fraction can subsequently be separated from the amorphous silicate and heated to evolve NH₃ gas and form an acidified solution containing NH₄HF₂. In some embodiments, the ammonia may be a solution. In some embodiments, the ammonia may be a gas. This example can be described by Reaction B.

### Ammonium Bifluoride Generation (Reaction B)

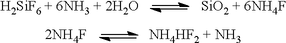

A solution of fluorosilicic acid (H₂SiF₆) is prepared by diluting 10.00 g of 35 wt. % of H₂SiF₆ in 250 ml of distilled H₂O in a PTFE round bottom flask. The flask and solution are stirred for 1 hour. A solution of 10 wt. % ammonium hydroxide (NH₄OH) is added dropwise (250 mL total) with subsequent precipitation of a white solid which is subsequently collected by filtration, washed with cold water (~50 mL) and dried at 100° C. overnight. The filtrate is collected and reduced to dryness under reduced pressure and elevated temperature to yield a white, crystalline solid. The SEM-EDS of the initial precipitate prior to filtration may show an amorphous solid composed of silicon and oxygen by EDS. The XRD of this material may indicate that the material is amorphous. The filtrate is then heated to boiling, with venting and collection of the evolved ammonia gas (NH₃) in a separate flask in an ice bath. The filtrate is further reduced to dryness and ammonium bifluoride (NH₄HF₂) is collected and dried under reduced pressure to yield a white crystalline solid.

### Example 3

This example describes a process for generating ammonium fluorosilicate (e.g., (NH₄)₂SiF₆). The process described generates an ammonium fluorosilicate through reaction of an acidified fluorosilicate (e.g., H₂SiF₆) with ammonia (NH₃) to generate ammonium fluorosilicate. The ammonium fluorosilicate(s) can be subsequently separated by precipitation (e.g., crystallization). In some embodiments, the ammonia may be a solution. In some embodiments, the ammonia may be a gas. This example can be described by Reaction C.

### Ammonium Hexafluorosilicate Generation (Reaction C)

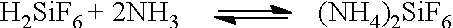

A solution of fluorosilicic acid (H₂SiF₆) is prepared by diluting 10.00 g of 35 wt. % of H₂SiF₆ in 250 ml of distilled H₂O in a PTFE round bottom flask. The flask and solution are stirred for 1 hour. A solution of 10 wt. % ammonium hydroxide (NH₄OH) is added dropwise until the pH is near-neutral. The solution is cooled in an ice bath, and precipitation of a white solid may be observed. The white solid is subsequently collected by filtration, washed with cold water (~10 mL), and dried at 100° C. overnight. The SEM-EDS of the precipitate may show a faceted solid composed of silicon, oxygen, nitrogen, and fluorine by EDS. The XRD of this material may indicate that the material is crystalline and assignable to (NH₄)₂SiF₆.

### Example 4

This example describes a thermochemical chemical loop process for the conversion of non-pozzolanic silica (SiO₂) unsuitable for cement production (crystalline with a low pozzolanic reactivity) into pozzolanic SiO₂ suitable for cement production (amorphous with a high pozzolanic reactivity). The process used the thermal decomposition of ammonium fluoride (NH₄F) to generate ammonium bifluoride (NH₄HF₂) and ammonia (NH₃) at elevated temperature (50<Tₒₚₑᵣₐₜᵢₒₙ<125° C.):

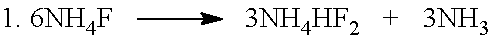

Ammonia was liberated from the ammonium bifluoride solution by heating. The dissolved NH₄HF₂ was subsequently used as a fluorinating agent to convert crystalline SiO₂ into ammonium fluorosilicate ((NH₄)₂SiF₆)) at 20-100° C.:

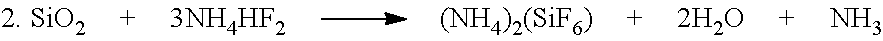

And the liberated ammonia (NH₃) from 1 and 2 was subsequently reintroduced to raise the pH and generate amorphous SiO₂,and NH₄F at around 20° C.:

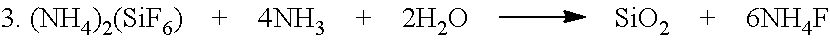

The amorphous SiO₂ was then filtered from the dissolution media, regenerating the initial reagent (NH₄F) and closing the chemical loop. Regeneration was carried out at a temperature of around 100° C.

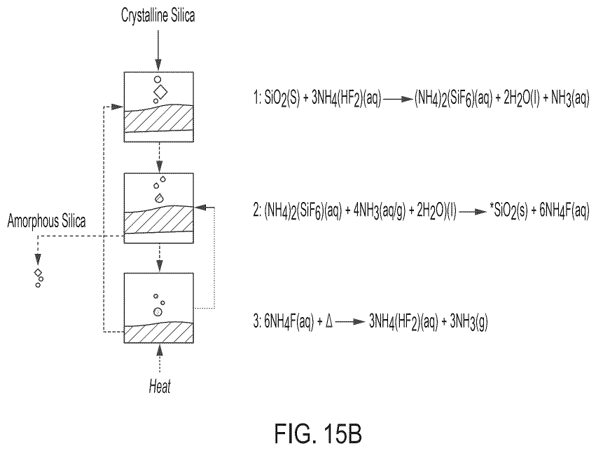

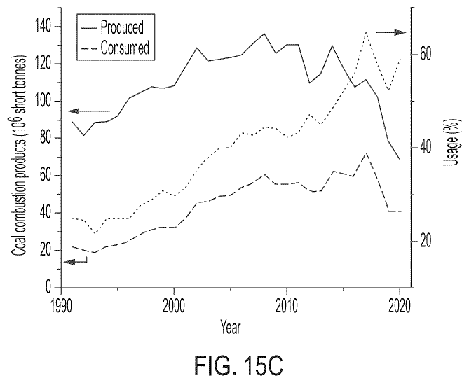

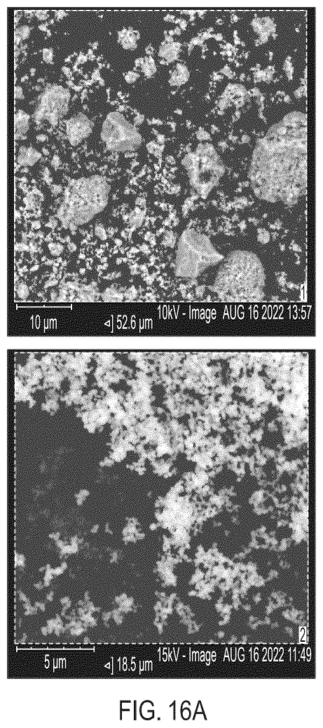

The process was operated as described in FIG. 15A with an operating temperature of 50° C. to 125° C. As shown in FIG. 15A, ammonium bifluoride was combined with crystalline silica to produce (NH₄)₂SiF₆, water, and ammonia in step 1. In step 2, ammonia, water, and (NH₄)₂SiF₆ were combined to produce ammonium fluoride and amorphous silica. In step 3, ammonium fluoride was heated to produce ammonium bifluoride and ammonia. When the system was operated below 125° C., the accumulation of hydrofluoric acid (HF) was avoided, such that SiO₂ was dissolved and precipitated without accumulation of HF.

A proposed 3-stage process is depicted in FIG. 15B. As shown in FIG. 15B, in some embodiments, the first stage of the 3-stage process comprises combining a silicate (e.g., crystalline silica) with ammonium bifluoride to produce ammonium hexafluorosilicate, water, and ammonia. In certain cases, as shown in FIG. 15B, the second stage of the 3-stage process comprises combining the ammonium hexafluorosilicate with ammonia and water to produce amorphous silica and ammonium fluoride. In some instances, as shown in FIG. 15B, the optional third stage of the 3-stage process comprises combining the ammonium fluoride and heat to generate ammonium bifluoride and ammonia, which, optionally, can be used in the first stage and second stages, respectively. Given the cost disparity between highly amorphous silica ($100-300/t) and highly crystalline silica (~$10/t), this process could form the basis of a new technology for valorization of crystalline silica sources that are currently of limited value to the cement industry. This statement is compounded by the fact that synthetic sources of pozzolanic silica—such as fly ash—are diminishing resources, and that the consumption of pozzolanic silica is increasing annually with no signs of abatement (FIG. 15C).

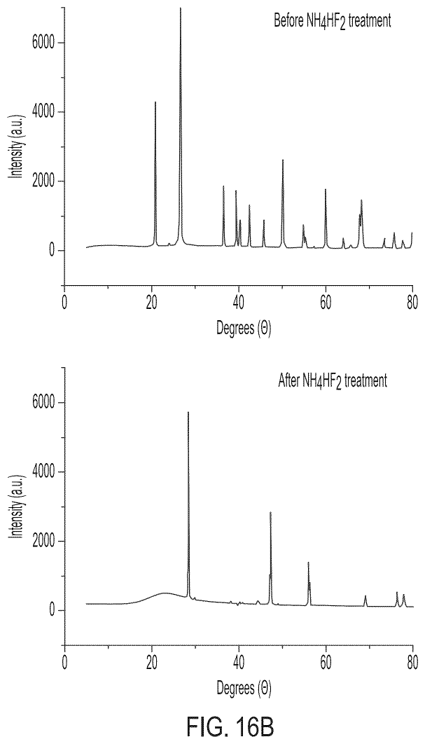

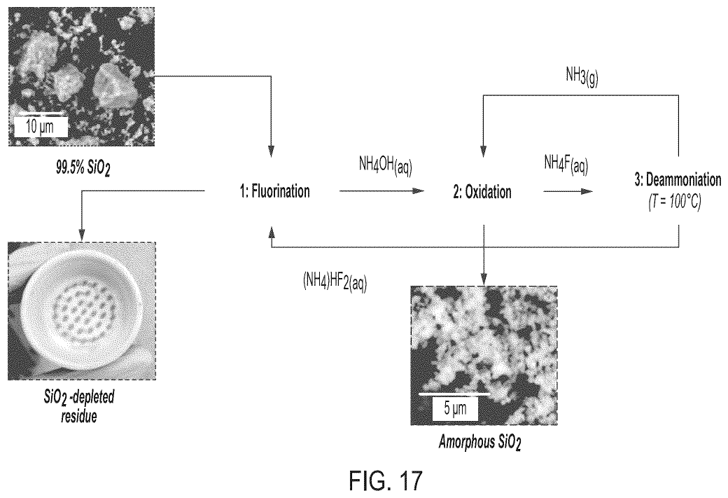

3. Data FIG. 16A and FIG. 16B show SEM images and XRD of crystalline quartz sand before and after being subjected to the process in FIG. 15A.

### Example 5

### Silicate Subtraction Process Overview

The silicate subtraction process described in this example utilized ammonium fluoride in a chemical loop that dissolved and subsequently precipitated silica. The process used ammonium bifluoride (NH₄HF₂) as a fluorinating agent to convert silica (SiO₂) into ammonium hexafluorosilicate ((NH₄)₂SiF₆), which was subsequently basified with aqueous ammonia (NH₃) to generate amorphous SiO₂ and ammonium fluoride (NH₄F). The solid SiO₂ was separated from the NH₄F solution by filtration, and the filtrate was subsequently heated to decompose NH₄F into NH₄₁HF₂ and NH₃, closing the chemical loop. The chemical cycle and mass balance is given below:

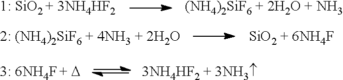

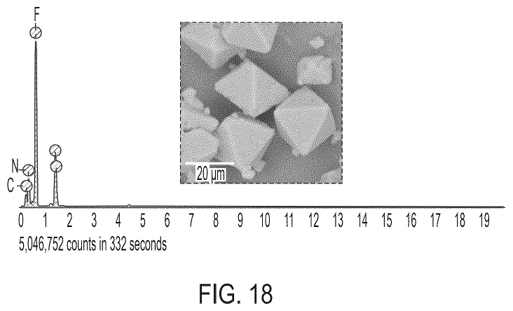

In some embodiments, the process operates at low temperature (e.g., <100° C.) in aqueous solution and provides a means of removing silica from various minerals or waste streams while concentrating remaining elements into a non-siliceous residue. A reaction was performed in a 1 L teflon reaction vessel under magnetic stirring with 5 g of a silica-rich feedstock, 25 g of NH₄HF₂, and 500 mL of H₂O. The majority of silica in most feedstocks was fully digested after 48 h, and the reaction time was strongly correlated with both the fineness of the sample (i.e., degree of mechanical processing) and the crystallinity of the feedstock. The precipitated silica was amorphous and fine (ø_{particle}=0.5-10.0 um), making it a potentially valuable co-product (~$100-250/t) with use as a pozzolan for the cement industry. The process flow for the overall process using technical-grade silica (99.5%, 400 mesh) is depicted in FIG. 17.

The application of this process for mineral processing could potentially either be as a standalone process for simple aluminosilicate minerals/wastes (e.g., REE-rich sands, kaolinite, montmorillonite) or as a downstream process for more complex minerals/wastes (e.g., bottom ash, ponded ash). Below is an analysis of the behavior of some minerals (kaolinite, montmorillonite, olivine, wollastonite, basalt rock) and wastes (bottom ash, ponded ash) when exposed to a strong fluorinating agent like NH₄HF₂, an analysis of their compatibility with the silicate subtraction process, and a discussion of the implications from this data for the viability of the process for various minerals.

### Reaction Conditions and Analysis Procedure

All reactions were carried out in a 500 mL teflon vessel with a screw-top and a magnetic stir bar. All reactions were performed in an oil bath at 25° C. and ambient pressure. Feedstock materials were mechanically crushed by hand with a mortar and pestle and passed through a 1.0 mm sieve before use. The vessel was charged with 5.0 g of the feedstock and 500 mL of H₂O. All samples were stirred for 10 minutes, followed by introduction of 25 g of technical grade NH₄HF₂ (Fisher Scientific). The samples would immediately cool upon introduction of NH₄HF₂ and the solution was typically pH ~4-5. Reactions were stirred at room temperature for 48 h, followed by filtration through a glass fiber filter to separate the insoluble material from the solubilized species. The filtrate were subsequently basified to pH 10-11 with concentrated NH₄OH (Fisher Scientific), with observable precipitation of a white solid. With high silica-content sources (99.5%, 400 mesh SiO₂) typical SiO₂ yields were >95%. With lower silica-content sources, SiO₂ yields varied, but silica remaining in the insoluble material after treatment was not observed.

The white solid was identified as amorphous silica, with a particle size dependent upon the rate and method of NH₄OH addition. Basification by titration with NH₄OH_{(aq)} resulted in a narrow particle size distribution and a mean particle diameter of ~0.5 μm. The particle size and distribution was comparable whether the titration was carried out slowly (~1 h) or rapidly (10 s). However, basification by fumigation with NH_{3(g)} over a period of several hours produced larger particles with a mean particle diameter of ~4.5 μm, and with a wider particle size distribution.

The insoluble residue varies depending on the mineral feedstock, and the siliceous precipitate was typically pure, except in high aluminum content samples where (NH₄)₃AlF₆ was observed in the precipitate after basification. The feedstock, siliceous precipitate, and the insoluble residue were all analyzed by SEM (morphological composition), EDS (elemental composition), and XRD (overall composition).

### Kaolinite

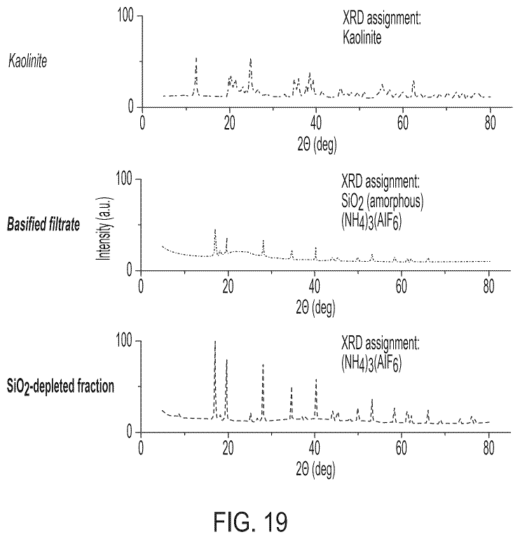

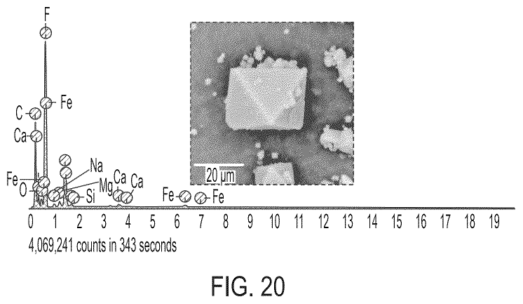

Kaolinite (Al₂O₃·2SiO₂·2H₂O, obtained from VWR) was subjected to the procedure described above. The yield of precipitate from the basified filtrate was ~3.0 g, which represents a ~129% yield with respect to dry SiO₂. Visually, the majority of the material dissolved, and the remaining insoluble material changed hue from off-white to a bright-white. The SEM-EDS map of the insoluble fraction revealed large octahedral crystals intermixed with smaller amorphous fractions, and a prominent signal for both N, F, and Al (FIG. 18). This was consistent with the XRD spectrum of the insoluble fraction, which was assigned to (NH₄)₃AlF₆ (FIG. 19, bottom), with no other crystalline material apparent in the spectrum and no trace of residual kaolinite. Thus the insoluble fraction was not a residue of the starting material, but rather, precipitated (NH₄)₃AlF₆ from the reaction. The basified filtrate showed a broad peak characteristic of amorphous silica, with a trace amount of (NH₄)₃AlF₆. Thus the chemical loop process appears to have dissolved and precipitated silica as was intended. The presence of residual (NH₄)₃AlF₆ in the silica was consistent with the large solubility difference between (NH₄)₂SiF₆ and (NH₄)₃AlF₆ and the yield 29% larger than expected for a pure SiO₂ product. At room temperature, (NH₄)₃AlF₆ appeared to not oxidize under conditions that readily oxidize (NH₄)₂SiF₆.

### Montmorillonite

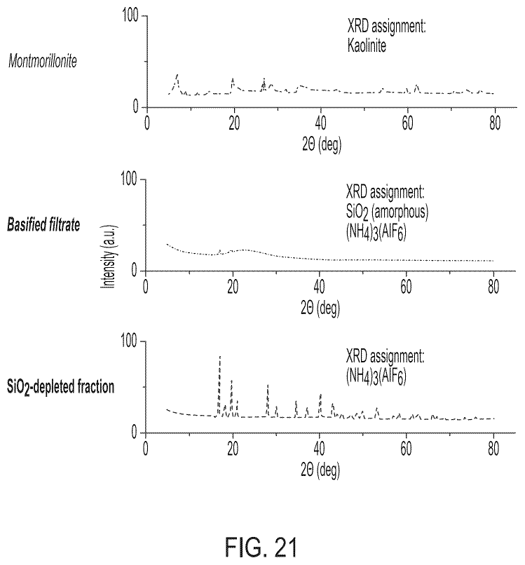

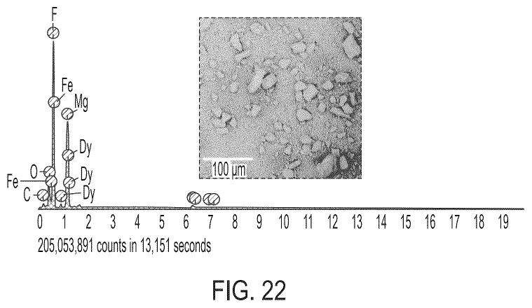

Montmorillonite ((Na, Ca)_{0.33}(Al,Mg)₂(Si₄O₁₀)(OH)₂·nH₂O), obtained from VWR) was subjected to the procedure described above. The yield of precipitate from the basified filtrate was ~2.5 g, which represents a ~75% yield with respect to silica assuming a hydration of n=10. Visually, the majority of the material dissolved, and the remaining insoluble material darkened in hue. Similar to kaolinite, the SEM-EDS map of the insoluble fraction revealed large octahedral crystals intermixed with smaller amorphous fractions, and signals for N, O, F, Al, Si Ca, Mg and Fe (FIG. 20). This was consistent with the XRD spectrum of the insoluble fraction, which was assigned to (NH₄)₃AlF₆ as well as residual montmorillonite (FIG. 21, bottom). Accordingly, both Si and Al appear to be removable using the ammonium bifluoride process, but the reaction time and/or temperature would need to be increased for total removal of Al and Si. Ca and Mg selectively concentrated in the insoluble residue, complicating the process and product separation. The basified filtrate showed a broad peak characteristic of amorphous silica, with a trace amount of (NH₄)₃AlF₆.

### Olivine

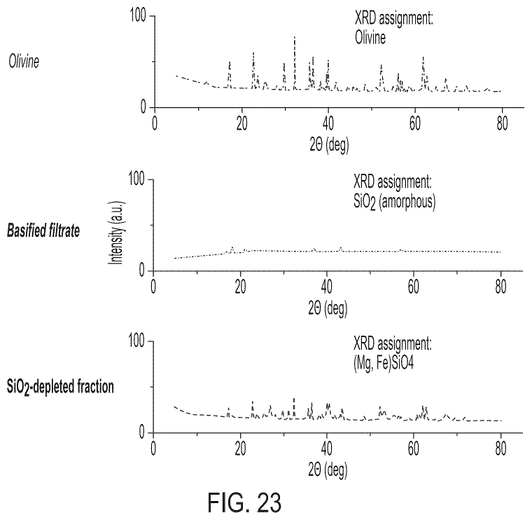

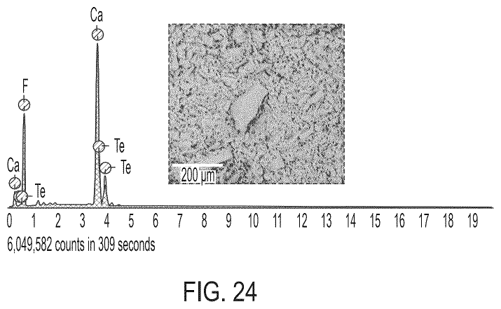

Olivine ((Mg, Fe)SiO₄), obtained from Southern Company) was subjected to the procedure described above. The yield of precipitate from the basified filtrate was ~2.8 g, which represents a ~123% yield with respect to silica. Visually, the majority of the material dissolved, and the remaining insoluble material darkened in hue. The SEM-EDS map of the SiO₂-depleted residue indicated large crystalline pieces ~20-50 μm across, intermixed with smaller pieces ~1-5 um across. Small quantities of Fe and O, and comparatively large quantities of Mg and F (FIG. 22) were observed throughout all particles. The XRD spectrum indicated residual olivine that was undissolved, although there was no Si signal within the SEM-EDS map. No peaks could be clearly assigned to MgF₂ in the XRD spectrum (FIG. 23), although the overlap with olivine was a possible convoluting factor. The presence of a strong F and Mg signal in the SEM-EDS map seemed to indicate the presence of MgF₂, particularly given that the absence of a N signal suggested that there was no residual NH₄F or NH₄HF₂. In summary, it appears that Si was completely removed from olivine, and that Fe remained in the SiO₂-depleted residue. Mg predictably formed MgF₂ that was concentrated in the SiO₂-residue, and the rate of mineral dissolution was comparatively slower than the studied pure aluminosilicates (e.g., kaolinite). The higher than expected yield of the precipitate from the basified filtrate was possibly due to incomplete drying.

### Wollastonite

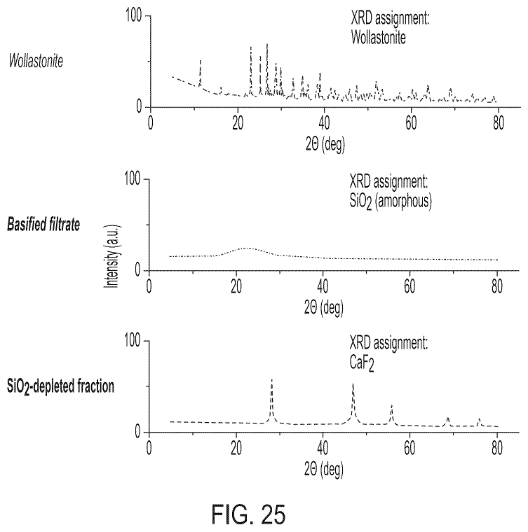

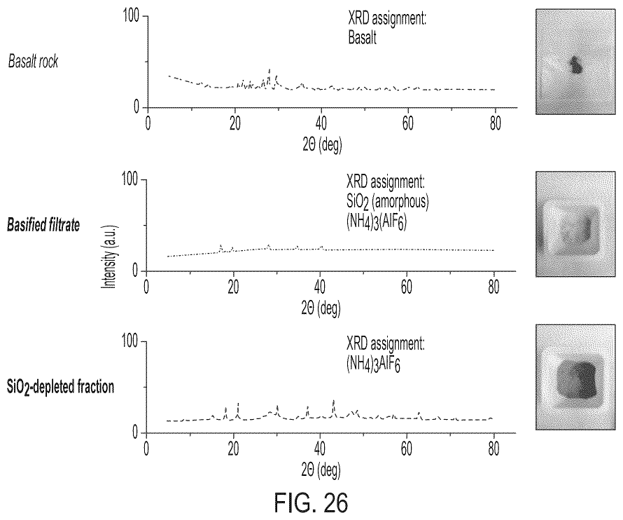

Wollastonite ((CaSiO₄), obtained from 7 Springs Farm (426 Jerry Ln, Check, VA 24072)) was subjected to the procedure described above. The yield of precipitate from the basified filtrate was ~2.43 g, which represents a ~94% yield with respect to silica. Visually, there was no observable change during the reaction. The SEM-EDS map of the SiO₂-depleted residue indicated that the material was primarily composed of Ca and F, with no observable Si peak (FIG. 24). The XRD spectrum supported the assignment of the residue as CaF₂, with the peaks having a full width half max that suggested the material was partially amorphous. The XRD spectrum of the basified filtrate indicated that it was composed of amorphous SiO₂, with no indication of fluorinated species (FIG. 25). The SEM-EDS (not depicted) of the amorphous SiO₂ supported this assignment. In summary, Si was completely leached from wollastonite.

### Basalt Rock

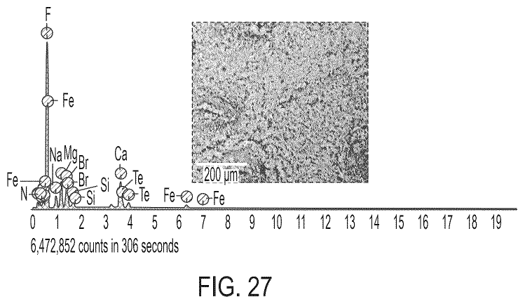

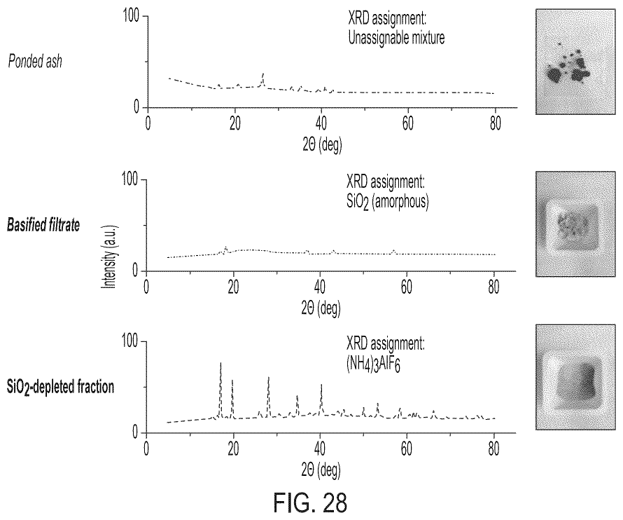

Basalt rock (obtained from S.S. Lane, MA, Westfield, 01085) was subjected to the procedure described above. The yield of precipitate from the basified filtrate was ~4.0 g (this yield may indicate that the precipitate was incompletely dried). Visually, the reaction mixture turned from dark brown to a light brown over the course of 48 h. The SEM-EDS map of the SiO₂-depleted residue indicated that the material was a varied mixture of N, O, F, Mg, Ca, Na, Fe, and Si. The XRD spectrum indicated that (NH₄)₃AlF₆ was the primary crystalline species in the residue, with trace (NH₄)₃AlF₆ accompanying the amorphous SiO₂ in the basified filtrate (FIG. 26). The presence of Fe in the SEM was supported by the red coloration in the SiO₂-depleted residue, but no peaks in the XRD could be assigned to simple Fe species. No peaks could also be clearly assigned to CaF₂ or MgF₂, despite the clear presence of both Ca and Mg within the EDS map (FIG. 27). In summary, Mg, Ca, Al, and Fe concentrated in the insoluble residue with Si and trace amounts of Al separating into the soluble fraction.

### Ponded Ash

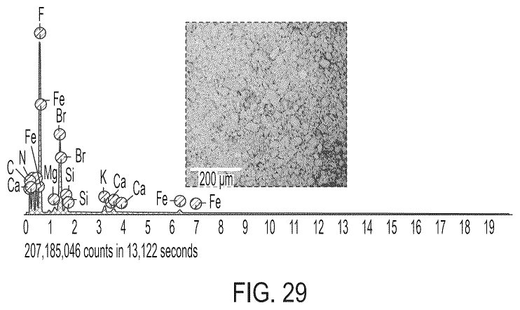

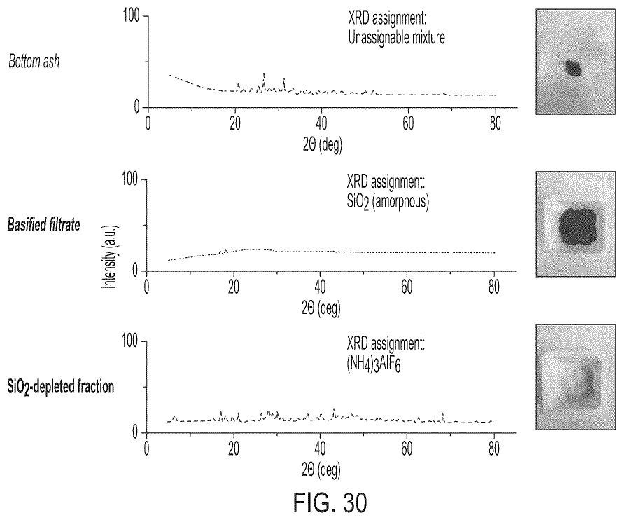

Ponded ash (obtained from Southern Company, 30 Ivan Allen Jr. Blvd. NW, Atlanta, GA 30308) was subjected to the procedure described above. The yield of precipitate from the basified filtrate was ~3.1 g. Visually, the reaction mixture turned from dark brown to a light brown over the course of 48 h. The SEM-EDS map of the SiO₂-depleted residue indicated that the material was a varied mixture of N, O, F, Mg, Ca, Na, Fe, and Si. The XRD spectrum indicated that (NH₄)₃AlF₆ was the primary crystalline species in the residue, with trace (NH₄)₃AlF₆ accompanying the amorphous SiO₂ in the basified filtrate (FIG. 28). The presence of Fe in the SEM was supported by the red coloration in the SiO₂-depleted residue, but no peaks in the XRD could be assigned to simple Fe species. No peaks could also be clearly assigned to CaF₂ or MgF₂, despite the clear presence of both Ca and Mg within the EDS map (FIG. 29). In summary, the final products of basalt rock and ponded ash appeared similar, with Mg, Ca, Al, and Fe concentrating in the insoluble residue. Si and trace amounts of Al were selectively precipitated from the basified filtrate.

### Bottom Ash

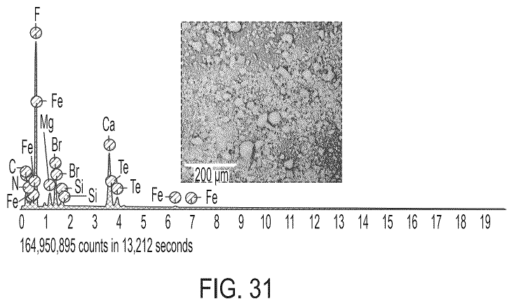

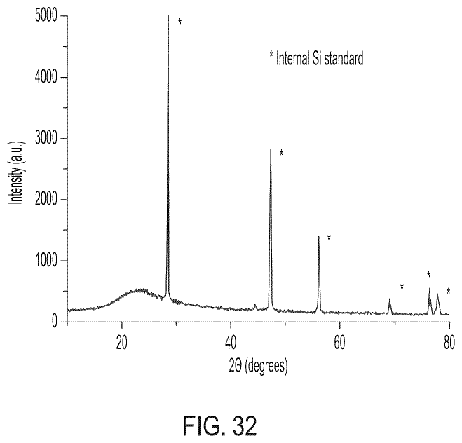

Bottom ash (obtained from Southern Company, 30 Ivan Allen Jr. Blvd. NW, Atlanta, GA 30308) was subjected to the procedure described above. The yield of precipitate from the basified filtrate was ~2.7 g. Visually, the reaction mixture turned from dark brown to a light brown over the course of 48 h. The SEM-EDS map of the SiO₂-depleted residue indicated that the material was a varied mixture of N, O, F, Mg, Ca, Na, Fe, and Si. The XRD spectrum indicated that (NH₄)₃AlF₆ was the primary crystalline species in the residue (FIG. 30). The presence of Fe in the SEM was supported by the red coloration in the SiO₂-depleted residue, but no peaks in the XRD could be assigned to simple Fe species. Less iron was observed than in either basalt rock or ponded ash. No peaks could also be clearly assigned to CaF₂ or MgF₂, despite the clear presence of both Ca and Mg within EDS map (FIG. 31). In summary, the final products of basalt rock, ponded ash, and bottom ash appeared similar, with Mg, Ca, Al, and Fe concentrating in the insoluble residue. Si and trace amounts of Al were selectively precipitated from the basified filtrate.

### Example 6

Synthesis of Amorphous Silica from SiO₂ (400 Mesh, 99.5%) and Ammonium Bifluoride:

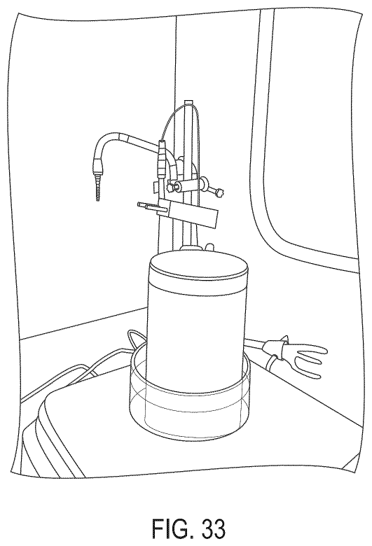

5.00 of SiO₂ (400 mesh, 99.5%) and 500 g of water was added to a PTFE round bottom flask containing a PTFE stir bar. The solution was stirred to form a suspension. The temperature was ~25° C. To this suspension, 25.00 g of NH₄HF₂ was added slowly. After 24 h, the solution—now clear—was decanted through a glass fiber membrane and precipitated by rapid basification of the solution with concentrated ammonium hydroxide to a final pH of 10-11. The precipitate was collected by filtration and washed with excess water. The collected solid was dried at 150° C. overnight to obtain a white powder that was further confirmed by XRD and SEM-EDS to be amorphous silica. Yield: ~4.8 g. FIG. 32 shows the XRD spectrum of the silica generated, with an internal Si powder reference. The broad peak with a maximum in the 20-25 range is characteristic of amorphous silica.

### HF Detection:

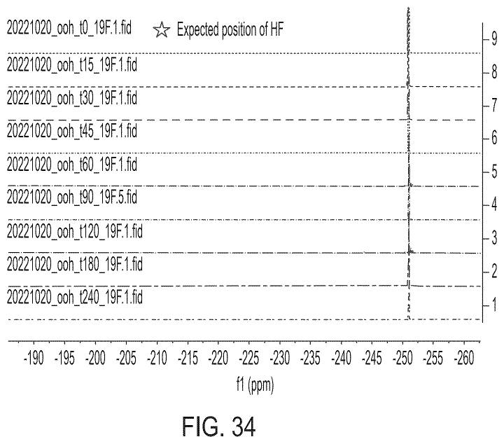

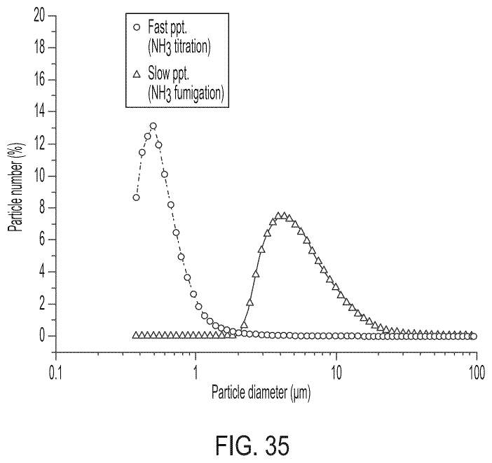

Even boiling solutions of NH₄F/NH₄HF₂ did not produce detectable free HF within or above the solution (FIGS. 33 and 34).

### Particle Diameters:

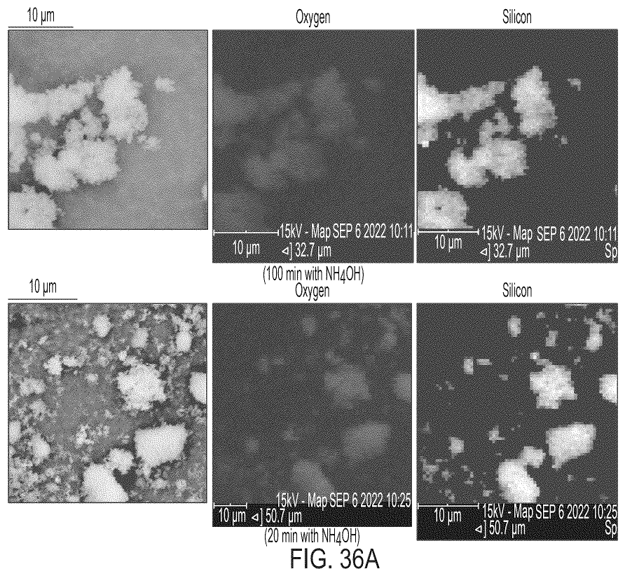

As shown in FIG. 35, desirable particle diameters (~5 um) were achieved by fumigation with NH₃ gas. The particle diameter of silica precipitated from fluorosilicate solutions by dropwise addition of concentrated NH₄OH (14.8 M) over the course of ~30 min (blue) was 0.5 microns. The particle diameter from slow fumigation with NH₃ gas over the course of −1 h was ~4.25 microns. Particle size was determined using a laser diffraction particle size analyzer (Beckman LS 13320).

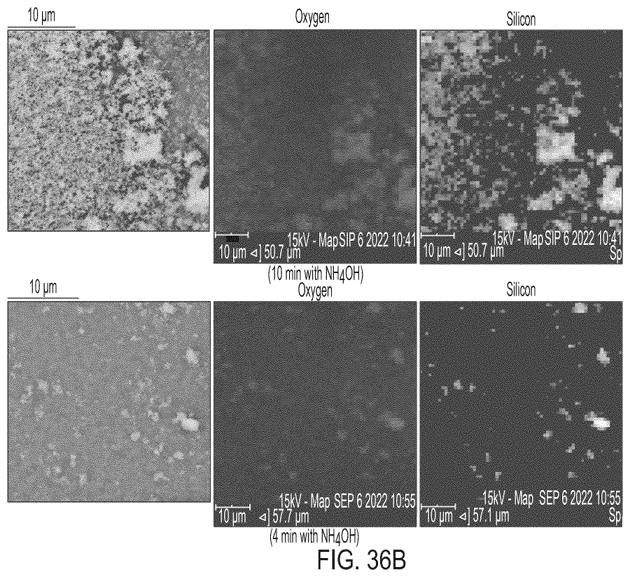

As shown in FIGS. 36A-36B, there was no large difference in the morphology for different precipitation rates. There was an observable density difference in the sample titrated slowly.

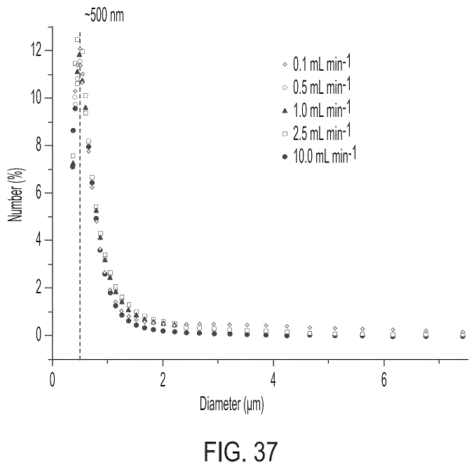

As shown in FIG. 37, extremely slow titration (>2 h) resulted in particle sizes larger than ~500 nm.

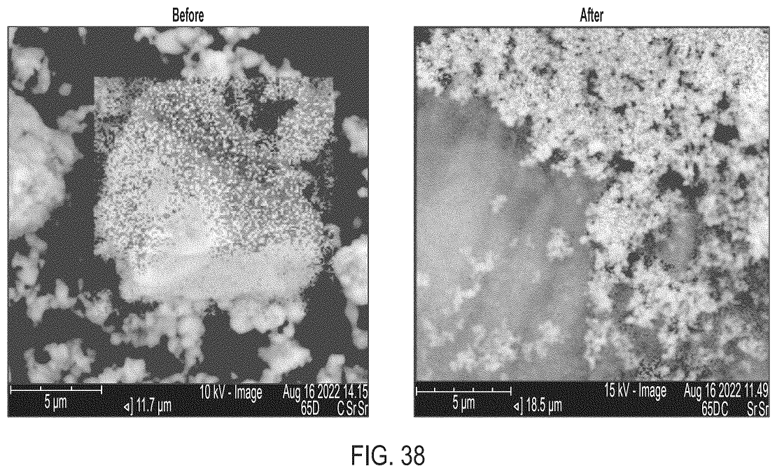

Powdered silica (99.5%; 400 mesh) was partially dissolved by pure ammonium bifluoride to form a fluorosilicate solution (3 h at RT). The fluorosilicate solution was precipitated with base to form silica (22% yield). The starting material was crystalline and coarse. As shown in FIG. 38, the precipitated product was amorphous and fine. The SiO₂ precipitate was collected from the filtrate after ammonium bifluoride treatment. The starting silica was dominantly crystalline (quartz). The precipitated silica was dominantly amorphous. In FIG. 16B, the left sharp peaks were mostly quartz and the right broad peak was glass.

A yield of 82.6% was achieved at room temperature with longer reaction time and more NH₄HF₂ equivalents (~18 h, 15 equivalents). 5.00 g SiO₂ (99.5%) in ~50 mL of H₂O, 3 molar equivalents of NH₄HF₂. RT for ~18 h with agitation. pH of solution after treatment was 4-5 by pH paper.

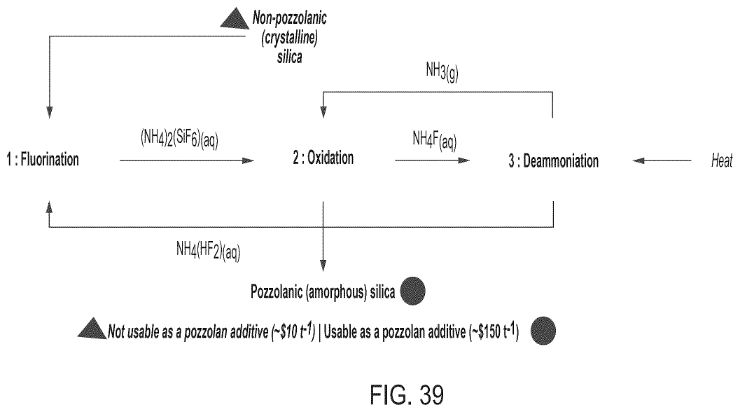

FIG. 39 shows a process for converting non-pozzolanic (crystalline) silica to pozzolanic (amorphous) silica using ammonium bifluoride, in accordance with some embodiments.

### Supplementary: Reaction Considerations

Reaction 1: SiO₂₍ₛ₎ reacts with (NH₄)(HF₂)_{(aq)} to generate (NH₄)₂(SiF₆)_{(aq)}.

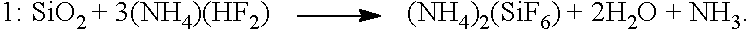

Reaction 2: (NH₄)₂(SiF₆)_{(aq)} reacts with NH_{3(aq)} to form SiO₂₍ₛ₎.

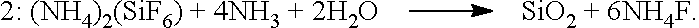

Reaction 3: NH_{3(aq)} reacts with NH₄F_{(aq)} to form (NH₄)(HF₂).

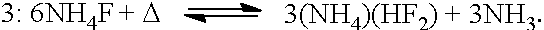

1-3 form a chemical loop for generating SiO₂₍ₛ₎.
The chemical loop started from (NH₄)(HF₂) or NH₄F. Evolution and removal of NH_{3(g)} drove the loop. Reintroduction of NH_{3(g)} maintained the loop. The chemical process did not accumulate hydrofluoric acid (IF).
Wanted primary reaction: NH₄F+Δ→NH₃ NH₄HF₂—~100° C.
Unwanted side reaction I: NH₄HF₂+Δ→NH₄F+HF—~120-220° C.
Unwanted side reaction II: NH₄F+HA_{strong}→NH₄A_{strong}+HF—~25° C.
HF preventative reaction: NH₃+HF→NH₄F+Δ—Any temperature
To produce 1 equivalent of HF from NH₄F, when 1 equivalent of NH₃ had already been generated it prevented HF from ever appreciably accumulating in the system. Moreover, decomposition of NH₄HF₂ only occurred at high temperature beyond the boiling point of aqueous solutions or with the introduction of an external strong acid. Ammonium bifluoride in boiling aqueous solutions did not form readily-detectable quantities of HF.

The tap density of the as-collected filter cake silica produced was about 0.75±0.10 g/cm³ and the tap density of the ground silica produced was about 0.35±0.02 g/cm³.

For the density determination of the as-collected filter cake, the density of the material was determined using the Archimedes method. Approximately 1 g of the filter cake was added (with minimal breaking and no grinding) to a 10 mL graduated cylinder. A small metal bar of known volume and mass was added to the top of the filter cake to keep the material from floating. The volume was adjusted to 10 mL with water, and the volume of the known mass of filter cake was subsequently recorded. The compacted filter cake was hydrophobic enough for the material to not absorb an appreciable amount of water during the timescale of the measurement. This measurement was repeated in triplicate to obtain the density of the filter cake.

For the tap density determination of the ground silica, the filter cake was ground in a mortar and pestle to yield a fine powder that readily aerosolized. A 10 mL graduated cylinder was filled to the 10 mL mark with ground silica, and the mass was recorded. This cylinder was then tapped for 15 min to reduce the volume, which was subsequently recorded. This procedure was repeated in triplicate to yield the tap density.

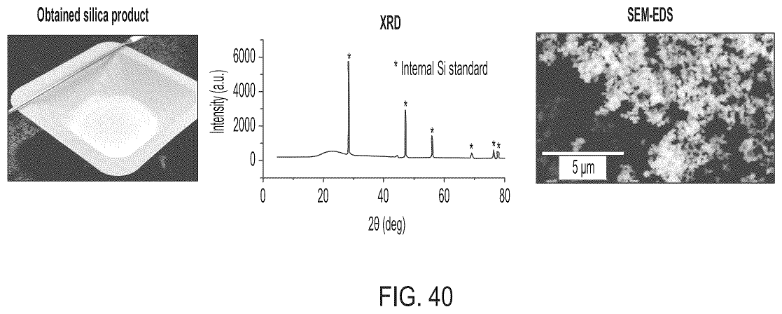

FIG. 40 shows a photo, XRD, and SEM-EDS of the silica product obtained from quartz sand. The results show that the silica product obtained was similar in structure to silica fume.

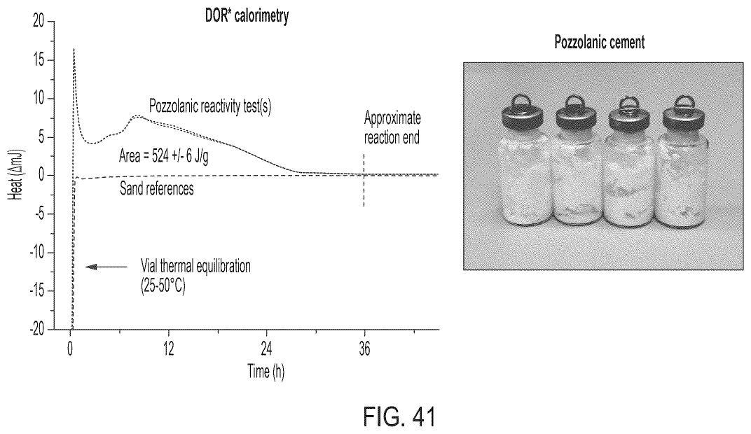

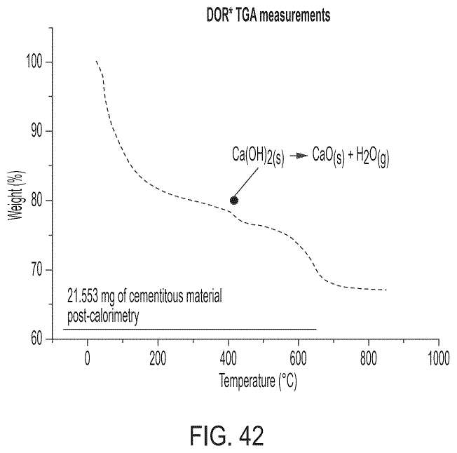

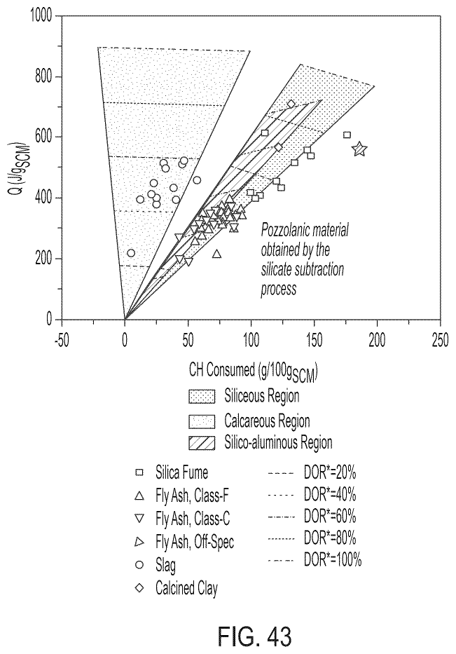

FIG. 41 shows DOR* calorimetry results (left) for the silica product obtained from quartz sand and a photo (right) of vials of pozzolanic cement made from the silica product obtained from quartz sand after curing at 50° C. for 48 hours. The silica product released about 524 J/g of silica when reacted with excess Ca(OH)₂. A pozzolanic reactivity test (PRT) was carried out on the amorphous silica. The PRT comprises a calorimetric experiment to measure the heat of reaction, and a thermogravimetric experiment to determine the amount of Ca(OH)₂ remaining in the sample (FIG. 42 and FIG. 43).

The PRT analysis conditions were as follows. 0.921 g of pozzolan (500 nm mean particle diameter, generated from 400 mesh quartz sand) was added to 2.7763 g of calcium hydroxide in a calorimetry vial. The solids were mixed using a vortex mixer for 30 s. To these solids, 3.316 g of 0.5 M KOH hydroxide solution—measured using a volumetric pipette that was calibrated with the basic solution using a gravimetric scale—was added and the resulting solution was mixed thoroughly with a metal spatula. These vials were capped and crimped and placed immediately within the calorimeter. A vial filled with 7.00 g of sand was used as a reference in separate channel. All measurements were performed in duplicate. The heat released was calculated using the integral of the region after thermal equilibration was reached to the 48 h mark. ~20 mg of material was loaded into a Pt TGA pan and heated from 20-850° C. with a ramp of 10° C./min and a 30 min hold at the final temperature. These TGA measurements were performed in triplicate.

PRT results thus obtained showed that the silica produced according to certain embodiments has exceedingly high reactivity, nearly identical to that of silica fume. The thermogravimetric analysis (TGA) demonstrated that about 184 g of Ca(OH)₂ were consumed per 100 g of pozzolan cement formed.

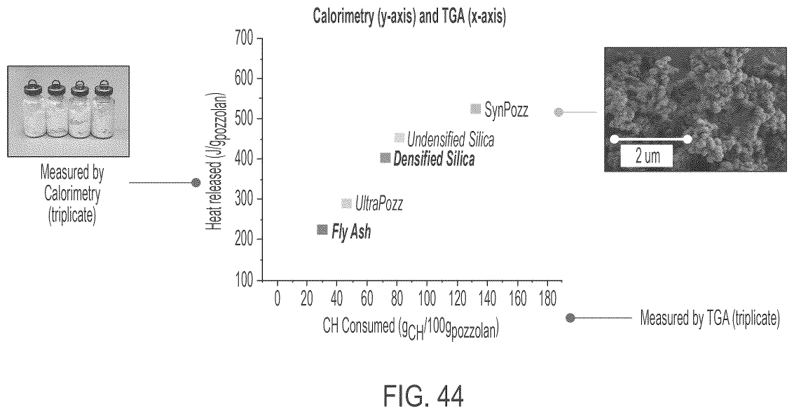

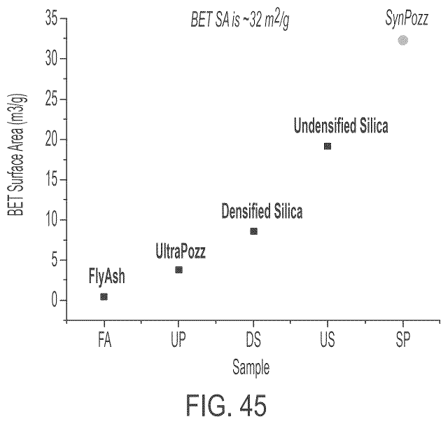

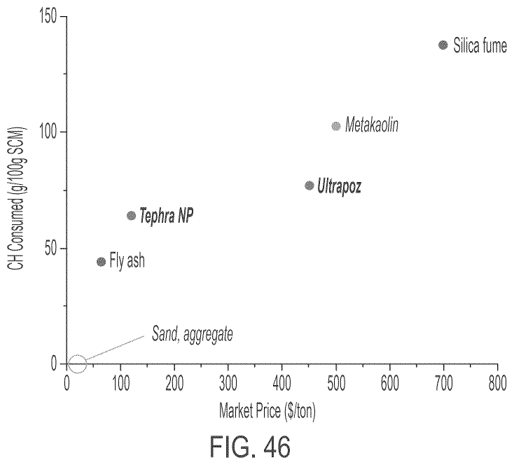

The reactivity of the generated pozzolanic silica (“SynPozz”) was plotted against other pozzolans using Pozzolanic Reactivity Testing (PRT) (FIG. 44). The pozzolanic silica generated (“SynPozz”) had the highest reactivity. FIG. 45 shows BET analysis of the generated pozzolanic silica (“SynPozz”) versus other pozzolans, demonstrating that the generated pozzolanic silica (“SynPozz”) had a higher surface area than undensified silica fume. This was measured using ASTM C1069-09 (Alumina and Quartz BET Surface Area). FIG. 46 plots the calcium hydroxide (“CH”) consumed (g/100 g SCM) during a standard pozzolanic reactivity test (which is a measure of reactivity) versus the market price ($/ton).

### Example 7

Valorization of spodumene to LIF, Al₂O₃, and SiO₂:

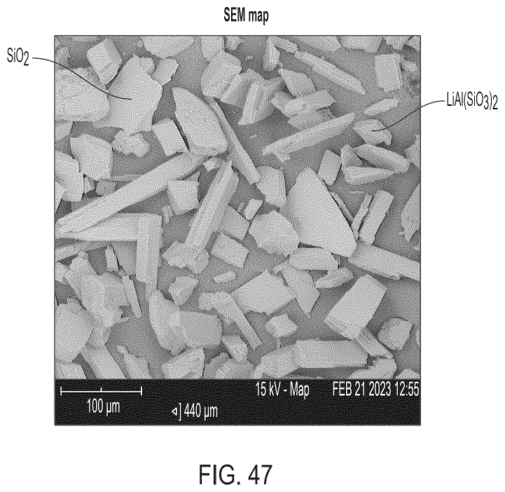

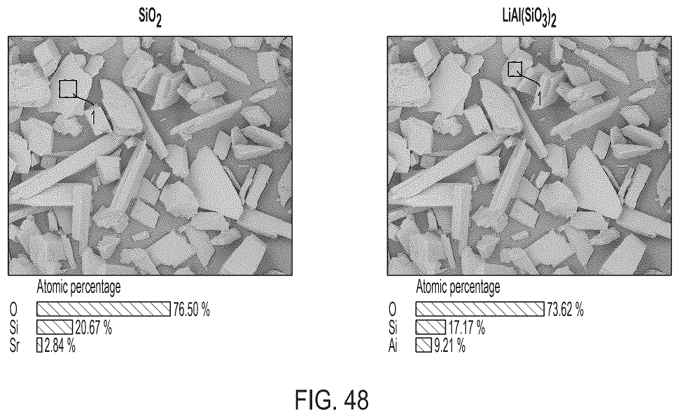

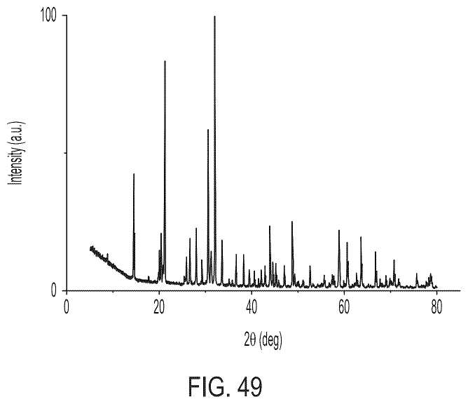

This example demonstrates the valorization of a spodumene sample (FIG. 47), in accordance with some embodiments. The spodumene sample was shown by X-ray diffraction (FIG. 48 and FIG. 49) to comprise about 90% spodumene phase and about 10% crystalline silica phase. The mean particle size (as determined by laser diffraction) was about 70 microns. The products of the process included LIF, Al₂O₃, and amorphous SiO₂.

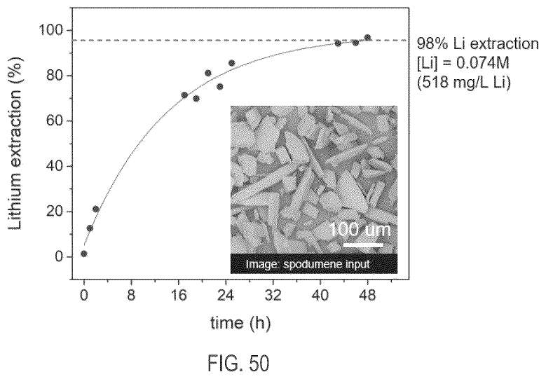

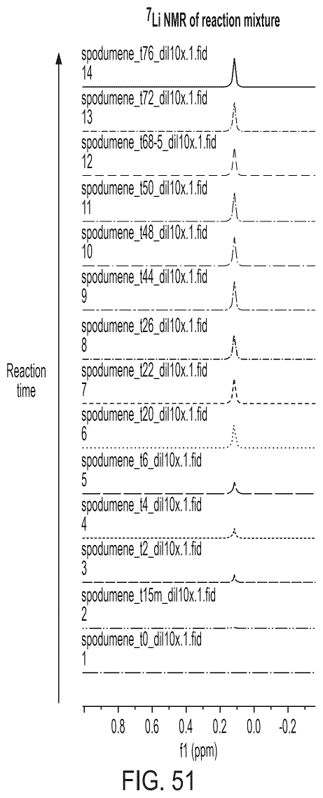

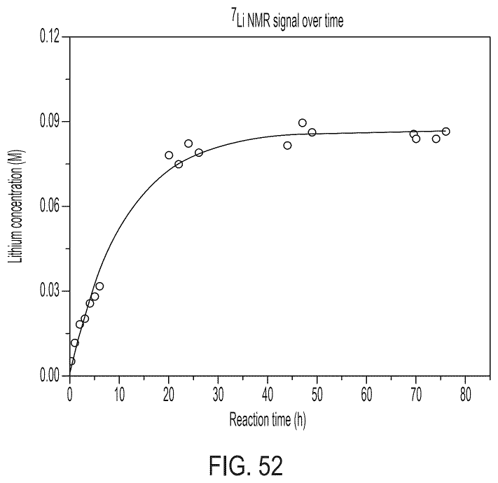

Experimental conditions: 500 g of water and 85 g of NH₄HF₂ were added to a PTFE round bottom flask containing a PTFE stir bar connected to a reflux condenser to recirculate cold water. The solution was stirred at −100° C. until the NH₄HF₂ dissolved. To this solution, 10.00 g of the spodumene sample was added. This suspension was stirred continuously and allowed to react for 48 hours. Reaction aliquots were taken periodically and the lithium concentration was measured by ⁷Li-NMR on the reaction aliquots (FIG. 50, FIG. 51, and FIG. 52). After 48 h the reaction mixture was cooled and the insoluble fraction was collected by filtration and washed with water. XRD analysis indicated that the insoluble product comprised primarily (NH₄)₃AlF₆. Yield: 9.50 g. The (NH₄)₃AlF₆ was then reacted in sequence with H₂SO₄ and NaOH at 60° C., each for ~48 h to generate Al(OH)₃, which was characterized by SEM and EDS. This Al(OH)₃ product may be converted into alumina (Al₂O₃) by heating to drive off H₂O.

To the remaining solution, ~150 g of NH₄OH was added and allowed to mix for 20 minutes before cooling in an ice bath. The resulting precipitate was collected by filtration and washed with excess water. The collected solid was dried at 150° C. overnight to obtain a white powder that was further confirmed by XRD and SEM-EDS to be amorphous silica. Yield: ~7.7 g. BET surface area measurements were carried out on the amorphous silica. BET surface area measurements were performed according to ASTM C1069-09.

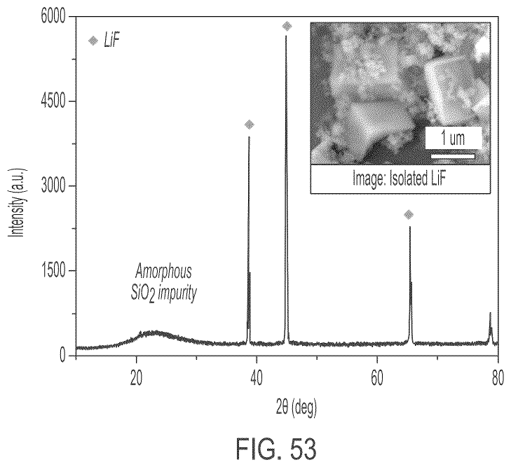

The remaining aqueous solution was then reduced in volume by heating in an oil bath at ~80° C. before adding ~100 g of NH₄OH. The resulting fine white precipitate was collected by centrifuging the solution and rinsing the product with water. The collected solid was dried at 100° C. overnight to obtain a white powder that was confirmed by XRD and SEM-EDS (FIG. 53) to be primarily LiF with a trace amount of amorphous silica.

For 5 grams of spodumene, the yield obtained was 89.0% for the silica (measured by mass), 95.1% for (NH₄)₃AlF_{6 (s)} (measured by mass), and 89.6% for LiHF_{2 (aq)} or Li⁺ (measured by Li-NMR).

### Example 8

This example demonstrates digestion of lepidolite to produce LiF, (M,NH₄)₃AlF₆, and amorphous SiO₂:

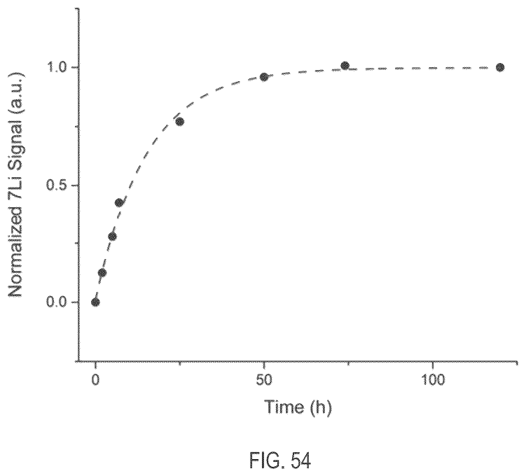

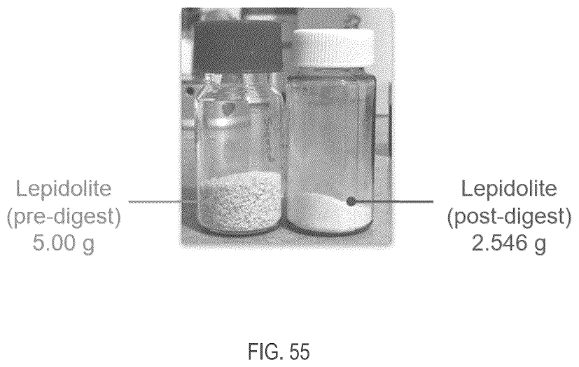

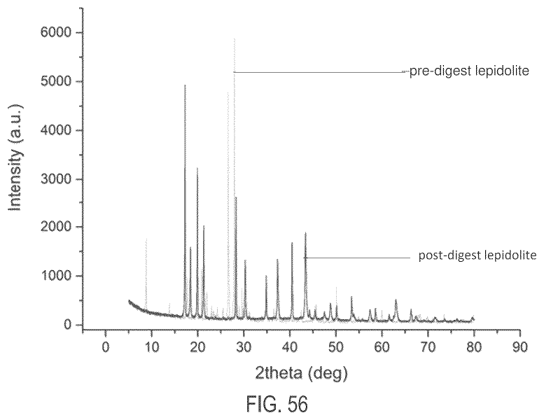

Experimental conditions: 250 g of water and 50 g of NH₄HF₂ were added to a PTFE screw-top vessel containing a PTFE stir bar. The solution was stirred at ~85° C. until the NH₄F₂ dissolved. To this solution, 5.00 g of the lepidolite sample was added. This suspension was stirred continuously and allowed to react for 120 h. As shown in FIG. 54, reaction aliquots were taken periodically and the lithium concentration was measured by ⁷Li-NMR on the reaction aliquots, and the data suggests full dissolution of the Li within the lepidolite sample after 120 h, corresponding to a dissolved Li concentration of 0.018 M. ⁷Li-NMR samples consisted of 300 μL sample, 400 μL H₂O, and 50 μL of a D₂O/CH₂FCN ¹⁹F internal standard. After 120 h the reaction mixture was cooled and the insoluble fraction was collected by filtration and washed with water (FIG. 55). XRD analysis indicated that the insoluble product comprised primarily (NH₄)₃AlF₆, along with trace (M,NH₄)₃AlF₆ (FIG. 56; see equation below). The composition was further characterized by SEM and EDS, which depicted angular crystals (~20 um) composed of Na, K, Al, O, F, and N (Li is undetectable by EDS).

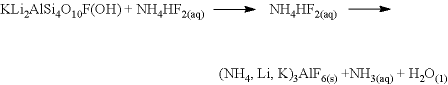

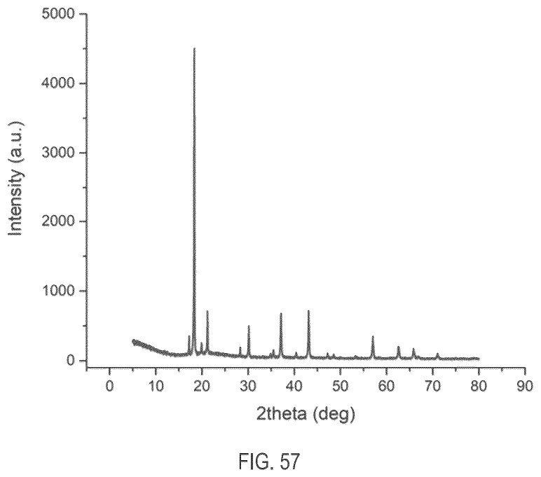

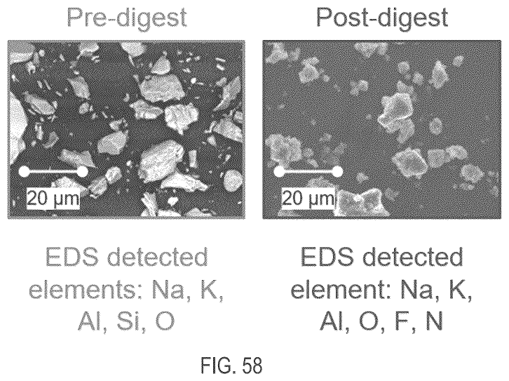

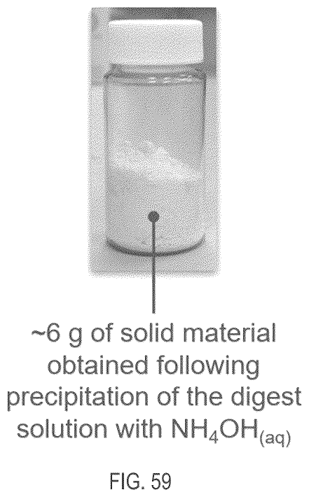

To the remaining solution, ~150 g of NH₄OH was added and allowed to mix for 20 minutes before cooling in an ice bath. The resulting precipitate was collected by filtration and washed with excess water. The collected solid was dried at 150° C. overnight to obtain a white powder that was further confirmed by XRD (FIG. 57) and SEM-EDS (FIG. 58) to be amorphous silica (see equation below). Yield: ~6.0 g (wet) (FIG. 59). The obtained silica was indistinguishable from that obtained in Example 5.

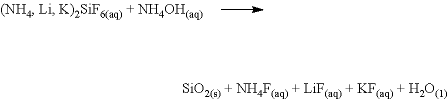

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
a) combining a material comprising a fluorosilicate with an amine to produce ammonium fluoride;
b) producing ammonium bifluoride and ammonia from the produced ammonium fluoride;
c) repeating step a), wherein the amine comprises the ammonia produced in step b); and
d) combining the produced ammonium fluoride and/or ammonium bifluoride with a material comprising silicate including lithium to produce at least ammonium hexafluorosilicate.

2. The method of claim 1, wherein step b) does not produce and/or accumulate a substantial net amount of hydrogen fluoride.

3. (canceled)

4. A method, comprising:
a) combining a material comprising a fluorosilicate with an amine to produce ammonium fluoride;
b) producing ammonium bifluoride from the produced ammonium fluoride, wherein step b) does not produce and/or accumulate a substantial net amount of hydrogen fluoride; and
c) combining the produced ammonium fluoride and/or ammonium bifluoride with a material comprising silicate including lithium to produce at least ammonium hexafluorosilicate.

5. The method of claim 4, wherein producing ammonium bifluoride from the produced ammonium fluoride also produces ammonia, and wherein the method further comprises repeating step a), wherein the amine comprises the ammonia produced in step b).

6. (canceled)

7. A method, comprising:
a) combining a material comprising a fluorosilicate with an amine to produce ammonium fluoride and/or ammonium bifluoride; and
b) combining the produced ammonium fluoride and/or ammonium bifluoride with a material comprising silicate including lithium to produce at least ammonium hexafluorosilicate.

8. The method of claim 7, wherein step a) comprises combining the material comprising a fluorosilicate with the amine to produce ammonium fluoride, wherein the method further comprises producing ammonium bifluoride and ammonia from the produced ammonium fluoride; and wherein the method further comprises repeating step a), wherein the amine comprises the produced ammonia.

9. The method of claim 7, wherein step a) comprises combining the material comprising a fluorosilicate with the amine to produce ammonium fluoride, wherein the method further comprises producing ammonium bifluoride from the produced ammonium fluoride; and wherein producing ammonium bifluoride from the produced ammonium fluoride does not produce and/or accumulate a substantial net amount of hydrogen fluoride.

10. (canceled)

11. The method of claim 7, wherein the material comprising silicate comprises spodumene.

12. The method of claim 7, wherein the material comprising a fluorosilicate comprises an acidic fluorosilicate.

13. The method of claim 12, wherein the acidic fluorosilicate comprises hexafluorosilicic acid (H₂SiF₆).

14. The method of claim 7, wherein the material comprising a fluorosilicate comprises a waste product.

15. The method of claim 14, wherein the waste product comprises a waste product from ore processing, fertilizer production, and/or aluminum production and/or refinement.

16. The method of claim 7, wherein the amine comprises an inorganic amine.

17. The method of claim 16, wherein the inorganic amine comprises ammonia.

18. The method of claim 7, wherein the amine comprises an organic amine.

19. The method of claim 18, wherein the organic amine comprises trimethylamine, triethylamine, tripropylamine, tributylamine, and/or pyridine.

20. The method of claim 7, wherein the ammonium fluoride and/or ammonium bifluoride comprises less than or equal to 20 wt. % silicon and/or less than or equal to 90 wt % impurities.

21. The method of claim 7, wherein combining the material comprising a fluorosilicate with the amine to produce ammonium fluoride and/or ammonium bifluoride comprises combining the material comprising a fluorosilicate with ammonia to produce ammonium fluoride and ammonium bifluoride.

22. The method of claim 7, wherein combining the material comprising a fluorosilicate with the amine to produce ammonium fluoride and/or ammonium bifluoride comprises combining the material comprising a fluorosilicate with ammonia to produce ammonium fluoride and a silicate.

23. The method of claim 7, wherein combining the produced ammonium fluoride and/or ammonium bifluoride with the material comprising silicate including lithium further produces an amorphous silicate.

24. A method, comprising:
a) combining a material comprising a fluorosilicate with an amine to produce ammonium fluoride;
b) producing ammonium bifluoride and ammonia from the produced ammonium fluoride;
c) combining the produced ammonium fluoride and/or ammonium bifluoride with a material comprising silicate to produce at least ammonium hexafluorosilicate; and
d) repeating step a), wherein the amine comprises the produced ammonia.

25. A method, comprising:
a) combining a material comprising a fluorosilicate with an amine to produce ammonium fluoride;
b) producing ammonium bifluoride and ammonia from the produced ammonium fluoride; and
c) repeating step a), wherein the amine comprises the ammonia produced in step b); and
d) combining the produced ammonium fluoride and/or ammonium bifluoride with a material comprising silicate including spodumene to produce at least ammonium hexafluorosilicate.
